(19) United States
(12) Patent Application Publication
(10) Pub. No.: US 2025/0372109 A1
(43) Pub. Date: Dec. 4, 2025

(54) AUDIO ENCODING METHOD, AUDIO DECODING METHOD, AND RELATED APPARATUS

(71) Applicant: HUAWEI TECHNOLOGIES CO., LTD., Shenzhen (CN)

(72) Inventors: Chunhui Du, Shenzhen (CN); Fan Fan, Shenzhen (CN); Zhuo Wang, Shenzhen (CN); Bin Feng, Shenzhen (CN)

(73) Assignee: HUAWEI TECHNOLOGIES CO., LTD., Shenzhen (CN)

(21) Appl. No.: 19/306,964

(22) Filed: Aug. 21, 2025

Related U.S. Application Data
(63) Continuation of application No. PCT/CN2023/133310, filed on Nov. 22, 2023.

(30) Foreign Application Priority Data
Feb. 28, 2023 (CN) 202310230205.8

(51) Int. Cl. G10L 19/022; G10L 19/02

(52) U.S. Cl. CPC G10L 19/022; G10L 19/0212

(57) ABSTRACT

An audio encoding method, an audio decoding method, and a related apparatus are provided, and belong to the audio encoding and decoding field. The method includes: framing an audio signal, to obtain a plurality of audio frames; performing integer windowing and folding on the plurality of audio frames based on a windowing and folding matrix of a target window function, to obtain a plurality of folded audio frames; performing integer time-frequency transform on the plurality of folded audio frames, to obtain a plurality of spectrums; and encoding the plurality of spectrums into a bitstream.

### CROSS-REFERENCE TO RELATED APPLICATIONS

This application is a continuation of International Application No. PCT/CN2023/133310, filed on Nov. 22, 2023, which claims priority to Chinese Patent Application No. 202310230205.8, filed on Feb. 28, 2023. The disclosures of the aforementioned applications are hereby incorporated by reference in their entireties.

### TECHNICAL FIELD

This application relates to the audio encoding and decoding field, and in particular, to an audio encoding method, an audio decoding method, and a related apparatus.

### BACKGROUND

Framing, and windowing and folding transform on an audio signal are important parts of audio encoding and decoding. Folding transform is, for example, modified discrete cosine transform (MDCT), modified discrete sine transform (MDST), or integer modified discrete cosine transform (INTMDCT). INTMDCT can transform an integer audio signal into an integer spectrum, and inverse transform of INTMDCT can restore the integer spectrum to the integer audio signal, to implement lossless transform of the audio signal. Current INTMDCT is mostly applicable to a non-low-delay symmetric window function, and is not applicable to a low-delay window function or an asymmetric window function.

### SUMMARY

The present disclosure provides an audio encoding method, an audio decoding method, and a related apparatus, which may be applicable to a non-low-delay or low-delay window function, and an asymmetric or symmetric window function. The technical solutions are as follows.

According to a first aspect, an audio encoding method is provided. The method includes: framing an audio signal, to obtain a plurality of audio frames; performing integer windowing and folding on the plurality of audio frames based on a windowing and folding matrix of a target window function, to obtain a plurality of folded audio frames; performing integer time-frequency transform on the plurality of folded audio frames, to obtain a plurality of spectrums; and encoding the plurality of spectrums into a bitstream.

The windowing and folding matrix provided in the present disclosure can be applied to a non-low-delay or low-delay window function and an asymmetric or symmetric window function. After integer windowing and folding are performed on the audio frame based on the windowing and folding matrix, integer time-frequency transform is performed on the folded audio frame, to obtain integer spectrum data. That is, the present disclosure provides a universal INTMDCT transform method. In this method, integer spectrum data can be obtained after a time-domain audio frame is transformed, to implement lossless transform of audio data.

In a possible implementation, the windowing and folding matrix is as follows:

$$F 1 = ( \begin{matrix}S & 0 \\ 0 & R\end{matrix} ) ( \begin{matrix}1 & \frac{{Sw}_{3} - 1}{- {Sw}_{1}} \\ 0 & 1\end{matrix} ) ( \begin{matrix}1 & 0 \\ - {Sw}_{1} & 1\end{matrix} ) ( \begin{matrix}1 & \frac{{Rw}_{2} - 1}{- {Sw}_{1}} \\ 0 & 1\end{matrix} ) ( \begin{matrix}S & 0 \\ 0 & R\end{matrix} ) .$$

S represents taking a forward order of a sequence, R represents taking a reverse order of a sequence, the target window function is evenly divided into four parts, w₁ represents a function value of a first part of the target window function, w₂ represents a function value of a second part of the target window function, and w₃ represents a function value of a third part of the target window function.

In a possible implementation, the target window function may be evenly divided into the four parts based on a window length of the target window function. In other words, the window length of the target window function is evenly divided into four parts, so that the target window function is evenly divided into the four parts. Quantities of function points included in the four parts are the same.

In a possible implementation, the target window function is divided into an overlapping region and a non-overlapping region, and the overlapping region and the non-overlapping region meet the following conditions:
both the overlapping region and the non-overlapping region meet Sw₃*Rw₂+Rw₄*Sw₁=1, where w₄ represents a function value of a fourth part of the target window function;
w₄ in the non-overlapping region is 0; and
w₁ in the non-overlapping region is not 0, and values of

$$\frac{{Sw}_{3} - 1}{- {Sw}_{1}} and \frac{{Rw}_{2} - 1}{- {Sw}_{1}}$$

in the non-overlapping region fall within a specified range.

That is, when the target window function meets the foregoing conditions, the windowing and folding matrix is applicable regardless of whether the target window function is a non-low-delay window function, a low-delay window function, an asymmetric window function, or a symmetric window function.

The specified range is a data representation range. In a possible implementation, the specified range is [−128, 128]. Certainly, a value of the specified range may vary with the data representation range.

The integer time-frequency transform is to transform the plurality of folded audio frames in time domain into frequency domain data. That is, the plurality of spectrums are the frequency domain data. The integer time-frequency transform may be INTDCT transform, integer DCT-IV transform, or the like. This is not limited in this embodiment of the present disclosure.

In a possible implementation, after performing integer time-frequency transform on the plurality of folded audio frames, to obtain the plurality of spectrums, the method further includes: performing integer mid/side INTMS channel transform on the plurality of spectrums based on a channel transform matrix. In this case, the plurality of spectrums on which INTMS channel transform is performed are encoded into the bitstream.

In a possible implementation, the channel transform matrix is as follows:

$$H 1 = ( \begin{matrix}1 & \frac{cos θ 1 - 1}{sin θ 1} \\ 0 & 1\end{matrix} ) ( \begin{matrix}1 & 0 \\ sin θ 1 & 1\end{matrix} ) ( \begin{matrix}1 & \frac{cos θ 1 - 1}{sin θ 1} \\ 0 & 1\end{matrix} ) .$$

θ1 represents an angle of rotation of channel transform.

According to a second aspect, an audio decoding method is provided. The method includes: parsing out a plurality of spectrums from a bitstream; performing integer time-frequency inverse transform on the plurality of spectrums, to obtain a plurality of first time-domain signals; performing integer dewindowing and unfolding on the plurality of first time-domain signals based on a dewindowing and unfolding matrix of a target window function, to obtain a plurality of second time-domain signals; and performing overlapping and addition on the plurality of second time-domain signals, to obtain a reconstructed audio signal.

The dewindowing and unfolding matrix provided in the present disclosure can be applied to a non-low-delay or low-delay window function and an asymmetric or symmetric window function. After integer dewindowing and unfolding are performed, based on the dewindowing and unfolding matrix, on a time domain signal obtained through integer time-frequency inverse transform, integer time domain data can be obtained. That is, the present disclosure provides a universal INTIMDCT transform method. According to the method, integer time domain data can be obtained after frequency domain data is transformed, to implement lossless inverse transform of audio data.

In a possible implementation, the dewindowing and unfolding matrix is as follows:

$$F 2 = ( \begin{matrix}S & 0 \\ 0 & R\end{matrix} ) ( \begin{matrix}1 & \frac{{Sw}_{3} - 1}{{Sw}_{1}} \\ 0 & 1\end{matrix} ) ( \begin{matrix}1 & 0 \\ {Sw}_{1} & 1\end{matrix} ) ( \begin{matrix}1 & \frac{{Rw}_{2} - 1}{{Sw}_{1}} \\ 0 & 1\end{matrix} ) ( \begin{matrix}S & 0 \\ 0 & R\end{matrix} ) .$$

S represents taking a forward order of a sequence, R represents taking a reverse order of a sequence, the target window function is evenly divided into four parts, w₁ represents a function value of a first part of the target window function, w₂ represents a function value of a second part of the target window function, and w₃ represents a function value of a third part of the target window function.

Integer time-frequency inverse transform used by a decoder side is inverse transform of integer time-frequency transform used by an encoder side. Integer time-frequency inverse transform used by the decoder side varies with integer time-frequency transform used by the encoder side. This is not limited in this embodiment of the present disclosure.

In a possible implementation, the target window function is divided into an overlapping region and a non-overlapping region, and the overlapping region and the non-overlapping region meet the following conditions:
both the overlapping region and the non-overlapping region meet Sw₃*Rw₂+Rw₄*Sw₁=1, where w₄ represents a function value of a fourth part of the target window function;
w₄ in the non-overlapping region is 0; and
w₁ in the non-overlapping region is not 0, and values of

$$\frac{{Sw}_{3} - 1}{- {Sw}_{1}} and \frac{{Rw}_{2} - 1}{- {Sw}_{1}}$$

in the non-overlapping region fall within a specified range.

That is, when the target window function meets the foregoing conditions, the dewindowing and unfolding matrix is applicable regardless of whether the target window function is a non-low-delay window function, a low-delay window function, an asymmetric window function, or a symmetric window function.

The specified range is a data representation range. In a possible implementation, the specified range is [−128, 128]. Certainly, a value of the specified range may vary with the data representation range.

In a possible implementation, before performing integer time-frequency inverse transform on the plurality of spectrums, to obtain the plurality of first time-domain signals, the method further includes: performing integer inverse mid/side INTIMS channel transform on the plurality of spectrums based on a channel inverse transform matrix. In this case, integer time-frequency inverse transform is performed on the plurality of spectrums on which INTIMS channel transform is performed, to obtain the plurality of first time-domain signals.

In a possible implementation, the channel inverse transform matrix is as follows:

$$H 2 = ( \begin{matrix}1 & \frac{- ( cos θ 2 - 1 )}{sin θ 2} \\ 0 & 1\end{matrix} ) ( \begin{matrix}1 & 0 \\ - sin θ 2 & 1\end{matrix} ) ( \begin{matrix}1 & \frac{- ( cos θ 2 - 1 )}{sin θ 2} \\ 0 & 1\end{matrix} ) .$$

θ2 represents an angle of rotation of channel inverse transform.

According to a third aspect, an audio encoding apparatus is provided. The audio encoding apparatus has a function of implementing a behavior of the audio encoding method in the first aspect. The audio encoding apparatus includes at least one module. The at least one module is configured to implement the audio encoding method provided in the first aspect.

According to a fourth aspect, an audio decoding apparatus is provided. The audio decoding apparatus has a function of implementing a behavior of the audio decoding method in the first aspect. The audio decoding apparatus includes at least one module. The at least one module is configured to implement the audio decoding method provided in the second aspect.

According to a fifth aspect, an audio encoding device is provided. The audio encoding device includes a processor and a memory, and the memory is configured to store a computer program for executing the audio encoding method provided in the first aspect. The processor is configured to execute the computer program stored in the memory, to implement the audio encoding method in the first aspect.

Optionally, the audio encoding device may further include a communication bus. The communication bus is configured to establish a connection between the processor and the memory.

According to a sixth aspect, an audio decoding device is provided. The audio decoding device includes a processor and a memory, and the memory is configured to store a computer program for performing the audio decoding method provided in the second aspect. The processor is configured to execute the computer program stored in the memory, to implement the audio decoding method in the second aspect.

Optionally, the audio decoding device may further include a communication bus. The communication bus is configured to establish a connection between the processor and the memory.

According to a seventh aspect, a computer-readable storage medium is provided. The storage medium stores instructions, and when the instructions run on a computer, the computer is enabled to perform the audio encoding method in the first aspect or the audio decoding method in the second aspect.

According to an eighth aspect, a computer program product including instructions is provided. When the instructions run on a computer, the computer is enabled to perform the audio encoding method in the first aspect or the audio decoding method in the second aspect. In other words, a computer program is provided. When the computer program runs on a computer, the computer is enabled to perform the audio encoding method in the first aspect or the audio decoding method in the second aspect.

Technical effects achieved in the third aspect to the eighth aspect are similar to the technical effects achieved by using corresponding technical means in the first aspect or the second aspect. Details are not described herein again.

### BRIEF DESCRIPTION OF DRAWINGS

FIG. 1 is a diagram of a Bluetooth interconnection scenario according to an embodiment of the present disclosure.

FIG. 2 is a diagram of a system architecture related to an audio signal processing method according to an embodiment of the present disclosure.

FIG. 3 is a diagram of an overall framework of audio encoding/decoding according to an embodiment of the present disclosure.

FIG. 4 is a diagram of showing an MDCT process according to an embodiment of the present disclosure.

FIG. 5 is a diagram of a low-delay window function according to an embodiment of the present disclosure.

FIG. 6 is a flowchart of an audio encoding method according to an embodiment of the present disclosure.

FIG. 7 is a flowchart of an audio decoding method according to an embodiment of the present disclosure.

FIG. 8 is a diagram of a structure of an audio encoding apparatus according to an embodiment of the present disclosure.

FIG. 9 is a diagram of a structure of an audio decoding apparatus according to an embodiment of the present disclosure.

FIG. 10 is a diagram of a structure of an electronic device according to an embodiment of the present disclosure.

### DESCRIPTION OF EMBODIMENTS

To make objectives, technical solutions, and advantages of embodiments of the present disclosure clearer, the following further describes implementations of the present disclosure in detail with reference to the accompanying drawings.

First, an implementation environment and background knowledge related to embodiments of the present disclosure are described.

As wireless Bluetooth devices such as true wireless stereo (TWS) headsets, smart speakers, and smartwatches are widely popularized and used in people's daily life, people's requirements for high-quality audio playing experience in various scenarios become increasingly urgent, especially in environments in which Bluetooth signals are vulnerable to interference, for example, subways, airports, and railway stations. In a Bluetooth interconnection scenario, due to a limit of a Bluetooth channel connecting an audio sending device and an audio receiving device on a data transmission size, when an audio signal is transmitted, to reduce a bandwidth occupied when the audio signal is transmitted, an audio encoder in the audio sending device is usually configured to encode the audio signal, and then an encoded audio signal is transmitted to the audio receiving device. After receiving the encoded audio signal, the audio receiving device needs to decode the encoded audio signal by using an audio decoder in the audio receiving device, and then plays a decoded audio signal. It can be learned that, while the wireless Bluetooth devices are popularized, various Bluetooth audio codecs are also promoted to flourish.

Currently, Bluetooth audio codecs include a sub-band encoder (sub-band coding, SBC), the Bluetooth advanced audio encoder (AAC) series (for example, AAC-LC, AAC-LD, AAC-HE, and AAC-HEv2) of the Moving Picture Experts Group (MPEG), the aptX series (for example, aptX, aptX HD, and aptX low latency) encoder, a low-latency high-definition audio codec (LHDC), a low-energy low-latency LC3 audio codec, an LC3plus, and the like.

It should be understood that an audio encoding method and an audio decoding method provided in embodiments of the present disclosure may be applied to the audio sending device (namely, an encoder side) and the audio receiving device (namely, a decoder side) in the Bluetooth interconnection scenario. Certainly, in an actual application, the method may be further applied to another short-range transmission scenario. In embodiments of the present disclosure, the Bluetooth interconnection scenario is used as an example for description.

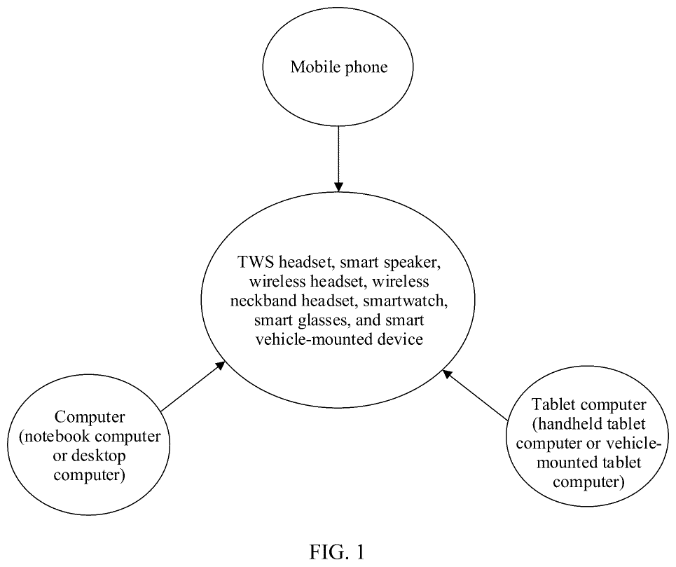

FIG. 1 is a diagram of a Bluetooth interconnection scenario according to an embodiment of the present disclosure. As shown in FIG. 1, the Bluetooth interconnection scenario includes an audio sending device and an audio receiving device. An audio encoder is configured for the audio sending device. An audio decoder is configured for the audio receiving device. The audio sending device may be a mobile phone, a computer, a tablet computer, or the like. The computer may be a notebook computer, a desktop computer, or the like, and the tablet computer may be a handheld tablet computer, a vehicle-mounted tablet computer, or the like. The audio receiving device may be a TWS headset, a smart speaker, a wireless headset, a wireless neckband headset, a smartwatch, smart glasses, a smart vehicle-mounted device, or the like. In some other embodiments, the audio receiving device in the Bluetooth interconnection scenario may alternatively be a mobile phone, a computer, a tablet computer, or the like.

It should be noted that, in addition to the Bluetooth interconnection scenario, the audio encoding method and the audio decoding method provided in embodiments of the present disclosure may be applied to another device interconnection scenario. In other words, a system architecture and a service scenario that are described in embodiments of the present disclosure are intended to describe the technical solutions in embodiments of the present disclosure more clearly, and do not constitute a limitation on the technical solutions provided in embodiments of the present disclosure. A person of ordinary skill in the art may learn that the technical solutions provided in embodiments of the present disclosure are also applicable to a similar technical problem as the system architecture evolves and a new service scenario emerges.

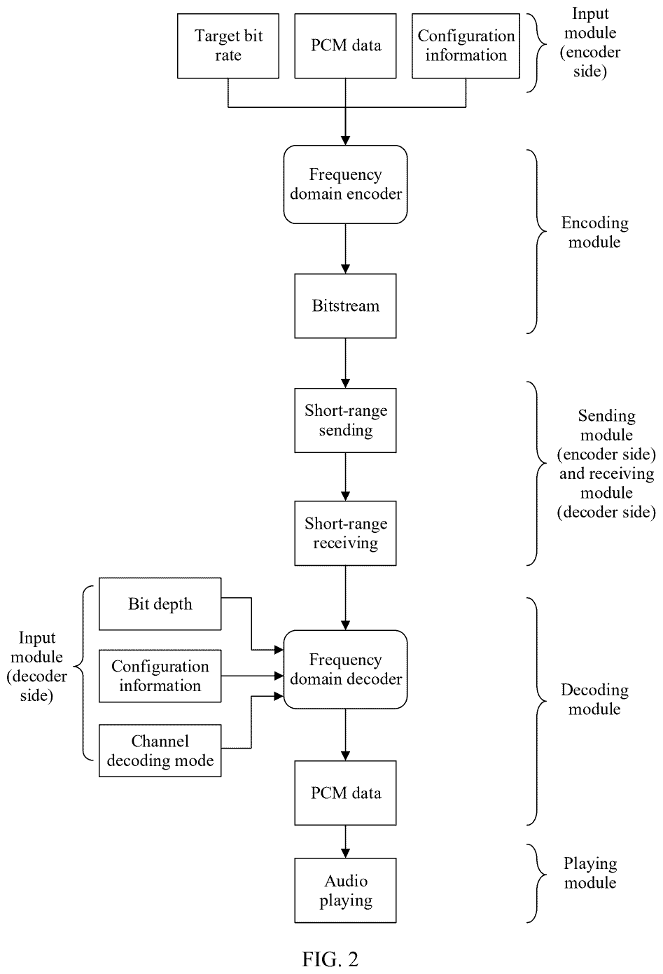

FIG. 2 is a diagram of a system architecture related to an audio signal processing method according to an embodiment of the present disclosure. As shown in FIG. 2, the system includes an encoder side and a decoder side. The encoder side includes an input module, an encoding module, and a sending module. The decoder side includes a receiving module, an input module, a decoding module, and a playing module.

On the encoder side, a user further needs to provide a to-be-encoded audio signal (pulse code modulation (PCM) data shown in FIG. 2) to the encoder side. In addition, the user further needs to set a target bit rate of a bitstream obtained through encoding, namely, an encoding bit rate of the audio signal. A higher target bit rate indicates better sound quality, but poorer anti-interference performance of a bitstream in a short-range transmission process. A lower target bit rate indicates poorer sound quality, but better anti-interference performance of the bitstream in the short-range transmission process.

In addition, the user needs to set other configuration information such as an encoding mode, a frame length, and delay information. This embodiment of the present disclosure may provide two encoding modes. The two encoding modes are a low-delay encoding mode and a high-sound quality encoding mode. The user determines one encoding mode from the two encoding modes based on a use scenario. For example, if the use scenario is playing a game, live streaming, calling, or the like, the user may select the low-delay encoding mode; and if the use scenario is enjoying music by using a headset or a speaker, or the like, the user may select the high-sound quality encoding mode. The frame length is a length of one frame of audio signal, and can be measured by time. For example, for the two encoding modes, a frame length of the low-delay encoding mode is 5 milliseconds (ms), and a frame length of the high-sound quality encoding mode is 10 ms. The delay information is whether to use low-delay transform when the audio signal is encoded.

In short, the input module of the encoder side obtains the target bit rate, the to-be-encoded audio signal, and the other configuration information that are submitted by the user. After obtaining data submitted by the user, the input module of the encoder side inputs, into a frequency domain encoder of the encoding module, the data submitted by the user.

The frequency domain encoder of the encoding module performs encoding based on the received data, to obtain the bitstream. The frequency domain encoder analyzes the to-be-encoded audio signal, to obtain a signal feature (including a single-channel/dual-channel signal, a stable/non-stable signal, a full-bandwidth/narrow-bandwidth signal, and the like). The audio signal enters a corresponding encoding processing submodule based on the signal feature and a bit rate level (namely, the target bit rate). The encoding processing submodule encodes the audio signal, and packages a header (including a sampling rate, a quantity of channels, the encoding mode, the frame length, and the like) of the bitstream, to finally obtain the bitstream.

The sending module of the encoder side sends the bitstream to the decoder side. For example, the sending module modulates a bitstream of a digital signal into an analog signal, and then transmits a radio wave through an antenna. Optionally, the sending module is a short-range sending module shown in FIG. 2 or another type of sending module. The short-range sending module may be Bluetooth or a wireless network. This is not limited in this embodiment of the present disclosure.

On the decoder side, the receiving module of the decoder side receives the bitstream, sends the bitstream to a frequency domain decoder of the decoding module, and notifies the input module of the decoder side to obtain a configured bit depth, configured configuration information, a configured channel decoding mode, and the like of the audio signal. For example, the receiving module receives the analog signal through the radio wave, and then demodulates the analog signal into the bitstream of the digital signal. Optionally, the receiving module is a short-range receiving module shown in FIG. 2 or another type of receiving module. The short-range receiving module may be Bluetooth or a wireless network. This is not limited in this embodiment of the present disclosure.

The input module of the decoder side inputs the information such as the bit depth, the configuration information, and the channel decoding mode of the audio signal into the frequency domain decoder of the decoding module.

The frequency domain decoder of the decoding module parses the bitstream based on the bit depth, the configuration information, the channel decoding mode, and the like of the audio signal, to obtain required audio data (the PCM data shown in FIG. 2), and sends the obtained audio data to the playing module. The playing module plays audio. The channel decoding mode indicates a channel that needs to be decoded, and the channel decoding mode may be indicated by a flag bit. The flag bit may be a first value, a second value, or a third value, the first value indicates a left-channel output, the second value indicates a right-channel value, and the third value indicates a stereo output. For example, the first value is 0, the second value is 1, and the third value is 2.

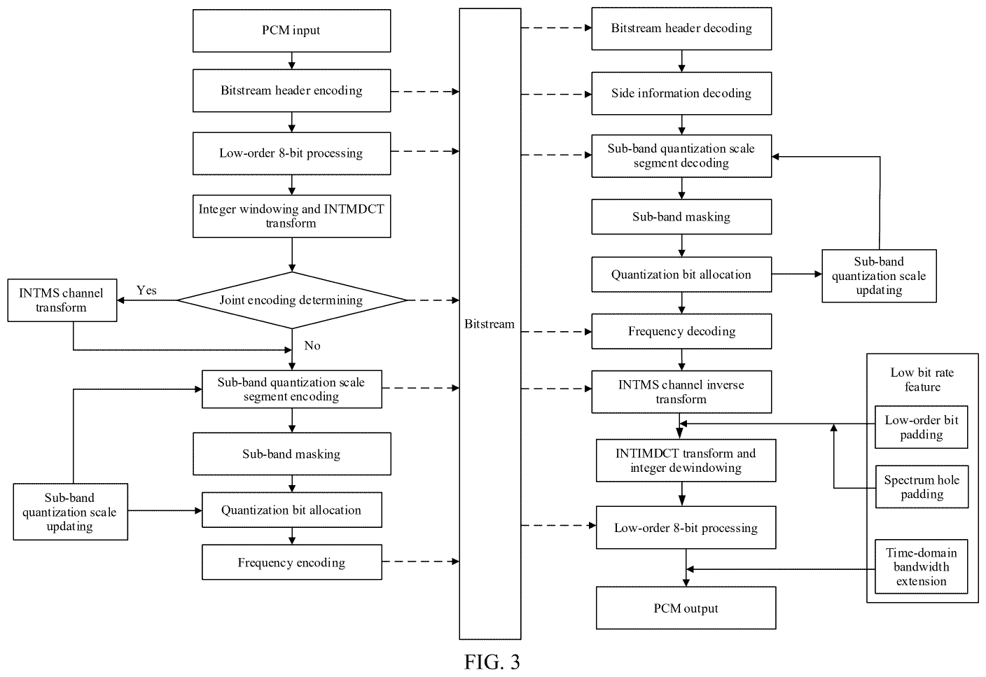

The following describes in detail an encoding part and a decoding part in the system architecture shown in FIG. 2. FIG. 3 is a diagram of an overall framework of audio encoding/decoding according to an embodiment of the present disclosure. In FIG. 3, there are two types of data streams. One is a control data stream (shown by a solid line), namely, a data stream obtained by performing a series of algorithm processing after an audio signal enters a frequency domain encoder and a bitstream enters a frequency domain decoder. The other is an encoded data stream (shown by a dashed line), namely, a data part that needs to be encoded into a bitstream and on which wireless transmission is performed, and a data stream that needs to be parsed by a decoder side.

The encoding part includes the following modules:

### (1) PCM Input Module

PCM data is input. The PCM data is single-channel data, dual-channel data, or multi-channel data. A bit depth of the PCM data may be a 16-bit, 24-bit, or 32-bit floating point, or a 32-bit fixed point. A supported sampling rate may be 44.1 kilohertz (kHz), 48 kHz, 88.2 kHz, 96 kHz, or the like. Optionally, the PCM input module transforms the input PCM data into a same bit depth, for example, a bit depth of 24 bits, performs deinterleaving on the PCM data, and then places the deinterleaved PCM data on each channel.

### (2) Bitstream Header Encoding Module

A sampling rate (for example, 44.1 kHz/48 kHz/88.2 kHz/96 kHz), a quantity of channels (for example, a single channel and dual channels), a bit depth, a frame length (for example, 5 ms and 10 ms), an encoding mode (for example, a time domain, a frequency domain, a time domain-to-frequency domain switching mode, or a frequency domain-to-time domain switching mode) of the PCM data are encoded into a bitstream.

### (3) Low-Order 8-Bit Processing Module

Whether low-order 8 bits of the PCM data are all 0s is detected. If the low-order 8 bits of the PCM data are all 0s, the sampling rate of the PCM data is shifted rightward by 8 bits; or if the low-order 8 bits of the PCM data are not all 0s, the sampling rate of the PCM data remains unchanged. Then, a flag bit indicating whether the sampling rate of the PCM data is shifted is encoded into the bitstream.

In some cases, a 16-bit sound source is transformed into a 24-bit sound source, a 24-bit sound source is transformed into a 32-bit sound source, or a 16-bit sound source is transformed into a 32-bit sound source. Therefore, a compression rate can be effectively improved after the sampling rate of the PCM data is shifted.

### (4) Integer Windowing and INTMDCT Transform Module

After integer windowing and INTMDCT transform are performed on PCM data obtained through processing performed by the module (3), spectrum data of an INTMDCT domain, namely, a spectrum of each frame of audio signal is obtained. Windowing is to prevent spectrum leakage.

INTMDCT is similar to MDCT, and includes two main processes: windowing and folding, and DCT (namely, DCT-IV) transform of a fourth type. A windowing and folding process of INTMDCT is different from that of MDCT, and DCT-IV transform is also integer time-frequency transform. Both input PCM data and an output spectrum of INTMDCT are integers. Inverse transform (namely, integer inverse modified discrete cosine transform (INTIMDCT)) can restore an integer spectrum to integer PCM data, which is completely bit-consistent with the input PCM data, only except for a sequence delay of several points, which is different from MDCT transform that has a floating point calculation error.

### (5) INTMS Channel Transform Module

INTMS channel transform is integer mid/side (INTMS) channel transform, and may also be referred to as integer mid/side stereo transform (INTMS transform).

The spectrum of each frame of audio data determined by the module (4) is a spectrum of a left/right (LR) channel. In this case, the spectrum of the LR channel is divided into sub-bands, to determine a sum of sub-band quantization scales of the LR channel, namely, a sum of quantization scales of all sub-bands of the LR channel. The quantization scale is a quantity of bits required for encoding a frequency with a maximum spectrum value in a corresponding sub-band. In addition, the spectrum of the LR channel is transformed into a spectrum of an MS channel, and the spectrum of the MS channel is divided into sub-bands, to determine a sum of sub-band quantization scales of the MS channel, namely, a sum of quantization scales of all sub-bands of the MS channel. If the sum of quantization scales of the MS channel is less than the sum of quantization scales of the LR channel, INTMS transform is performed on the spectrum of the LR channel.

It should be noted that the INTMS channel transform is for dual-channel PCM data. To be specific, for the dual-channel PCM data, after spectrum data is calculated by the module (4), joint encoding determining is performed based on the sum of quantization scales of the LR channel and the sum of quantization scales of the MS channel, to determine whether to perform INTMS channel transform on left/right-channel data. INTMS transform may not be performed for a single channel and a plurality of channels greater than dual channels.

After joint determining is performed, a flag bit indicating whether to perform INTMS channel transform may be further encoded into the bitstream.

### (6) Sub-Band Quantization Scale Segment Encoding Module

For a frame of audio signal obtained through processing performed by the module (5), in this embodiment of the present disclosure, hierarchical quantization and encoding are performed on a sub-band included in a spectrum of the frame of audio signal, or a plurality of times of cyclic quantization and encoding are performed. To be specific, a plurality of sub-bands included in the spectrum are classified into a plurality of parts, and sub-bands of two adjacent parts may overlap or may not overlap. After quantization and encoding are performed on a part of sub-bands, quantization and encoding are performed on a next part of sub-bands. Therefore, a maximum bandwidth that is currently allowed to be encoded and a corresponding sub-band may be determined based on information such as a quantity of currently encoded bits, a quantity of channels, and a quantity of sampling points, and these sub-bands are used as current to-be-encoded sub-bands. Then, sub-bands whose quantization scales are not encoded in the current to-be-encoded sub-bands are determined, and the quantization scales of these sub-bands are encoded into the bitstream.

### (7) Sub-Band Masking Module

For the current to-be-encoded sub-bands determined by the module (6), sub-band masking is performed on quantization scales of the current to-be-encoded sub-bands by using an adjacent sub-band in a psychoacoustic masking manner, to obtain quantization scales obtained through sub-band masking.

### (8) Quantization Bit Allocation Module

The quantization scales obtained by performing sub-band masking calculation by the module (7) are scaled to fall within a quantization step, and then, quantization bits are allocated to all the current to-be-encoded sub-bands based on the scaled quantization scales.

For each cycle, the quantization step may be the same or may be different.

### (9) Sub-Band Quantization Scale Updating Module

After the quantization bits are allocated to all the current to-be-encoded sub-bands by the module (8), remaining quantization scales of the sub-bands are updated based on the quantization bits allocated to the sub-bands, and a next cycle is entered.

### (10) Frequency Encoding Module

After the quantization bits are allocated to all the current to-be-encoded sub-bands by the module (8), a frequency in the sub-bands is encoded into the bitstream in an entropy encoding or binary encoding manner based on the quantization bits allocated to all the sub-bands.

Entropy encoding may be Hoffman encoding, or certainly, may be another encoding manner.

The decoding part includes the following modules:

### (1) Bitstream Header Parsing Module

Header information is parsed out from the received bitstream. The header information includes information such as the sampling rate, channel information, the frame length, and the encoding mode of the audio signal, and a target bit rate, namely, an encoding bit rate, or referred to as bit rate level information, is calculated based on a bitstream size, the sampling rate, the frame length, and the like.

### (2) Side Information Decoding Module

Side information is obtained through decoding from the bitstream, including information such as a flag bit indicating whether the sampling rate of the PCM data is shifted, a flag bit indicating whether to perform INTMS channel transform, or the quantization step, and other configuration information.

### (3) Sub-Band Quantization Scale Segment Decoding Module

When an encoder side performs hierarchical quantization and encoding or cyclic quantization and encoding, the decoder side also performs hierarchical decoding or cyclic decoding. To be specific, a maximum bandwidth that is currently allowed to be decoded and a corresponding sub-band may be calculated based on the information such as a quantity of currently decoded bits, the quantity of channels, and the quantity of sampling points, and these sub-bands are used as current to-be-decoded sub-bands. Then, sub-bands whose quantization scales are not decoded in the current to-be-decoded sub-bands are determined, and the quantization scales of these sub-bands are parsed out from the bitstream.

### (4) Sub-Band Masking Module

For the current to-be-decoded sub-bands determined by the module (3), sub-band masking is performed on quantization scales of the current to-be-decoded sub-bands by using an adjacent sub-band in a psychoacoustic masking manner, to obtain quantization scales obtained through sub-band masking.

### (5) Quantization Bit Allocation Module

The quantization scales obtained by performing sub-band masking calculation by the module (4) are scaled to fall within a quantization step, and then, quantization bits are allocated to all the current to-be-decoded sub-bands based on the scaled quantization scales.

For each cycle, the quantization step may be the same or may be different.

### (6) Sub-Band Quantization Scale Updating Module

After the quantization bits are allocated to all the current to-be-decoded sub-bands by the module (5), remaining quantization scales of the sub-bands are updated based on the quantization bits allocated to the sub-bands, and a next cycle is entered.

### (7) Frequency Decoding Module

After the quantization bits are allocated to all the current to-be-decoded sub-bands by the module (5), a frequency in the sub-bands is parsed out from the bitstream in an entropy decoding or binary decoding manner based on the quantization bits allocated to all the sub-bands.

Entropy decoding may be Hoffman decoding, or certainly, may be another decoding manner.

### (8) INTMS Channel Inverse Transform Module

After the spectrum data is parsed out by the module (7), whether to perform INTMS channel inverse transform is determined based on the flag bit that indicates whether to perform INTMS channel transform and that is parsed out from the bitstream by the module (2). If INTMS channel inverse transform needs to be performed, INTMS channel inverse transform is performed on the parsed out spectral data, to obtain spectral data of the LR channel.

The INTMS channel inverse transform is also referred to as an integer inverse mid/side (integer inverse mid/side, INTIMS) channel transform, or an integer inverse mid/side stereo transform (integer inverse mid/side stereo transform coding, INTIMS transform for short).

### (9) INTIMDCT Transform and Integer Dewindowing Module

INTIMDCT transform and integer dewindowing are performed on the spectrum data that is of the LR channel and that is obtained by the module (8), to obtain the PCM data.

INTIMDCT is similar to IMDCT, and includes two main processes: DCT-IV transform and dewindowing and unfolding. However, DCT-IV transform and dewindowing and unfolding processes of INTIMDCT are different from those of IMDCT. An input spectrum and output PCM data of INTIMDCT are integers.

### (10) Low-Order 8-Bit Processing Module

Whether to shift, leftward by 8 bits, a sampling point value of the PCM data obtained by the module (9) is determined based on the flag bit indicating whether the sampling rate of the PCM data parsed out from the bitstream by the module (2) is shifted.

### (11) PCM Output Module

PCM data of a corresponding channel is output based on a configured bit depth and channel decoding mode.

### (12) Low Bit Rate Feature Module

The decoder side provides some optional modules for decoding in a lossy state, to improve sound quality. Low-order bit padding is performed on a frequency from which a high-order bit is obtained through decoding but a low-order bit is not obtained through decoding. The low-order bit that is not obtained through decoding is padded in a form of a random bit. Spectrum hole padding is performed on a frequency whose sub-band quantization scale is not zero but a value obtained through decoding is zero, and a random number is generated based on the sub-band quantization scale for replacement. Time-domain bandwidth extension is to extend a bandwidth of the output PCM data to a full band.

It should be noted that the audio encoding and decoding framework shown in FIG. 3 is merely used as an example of a terminal in embodiments of the present disclosure, and is not intended to limit embodiments of the present disclosure. A person skilled in the art may obtain another encoding and decoding framework on the basis of FIG. 3.

The following describes a principle of overlapping transform in embodiments of the present disclosure. Overlapping transform may be MDCT, MDST, INTMCT, or other types of overlapping transform. A principle of INTMDCT is described herein by using the MDCT.

After framing an audio signal to obtain a plurality of audio frames, an encoder side windows the plurality of audio frames to obtain a plurality of windowed audio frames, and then performs MDCT on the plurality of windowed audio frames based on Formula (1), to obtain a plurality of spectrums. Alternatively, windowing and MDCT are directly performed on the plurality of audio frames based on Formula (2), to obtain a plurality of spectrums.

$${X}_{k} = {\sum }_{i = 0}^{2 N - 1} {x}_{i} cos [ \frac{π}{N} ( i + \frac{1}{2} + \frac{N}{2} ) ( k + \frac{1}{2} ) ] , k = 0 , … , N - 1 \qquad ( 1 )$$

$${X}_{k} = {\sum }_{i = 0}^{2 N - 1} {w}_{i} {x}_{i} cos [ \frac{π}{N} ( i + \frac{1}{2} + \frac{N}{2} ) ( k + \frac{1}{2} ) ] , k = 0 , … , N - 1 \qquad ( 2 )$$

Refer to Formula (1) and Formula (2). One audio frame includes N sampling points, every two adjacent audio frames form one audio segment, and one audio segment includes 2N sampling points. After performing windowing and MDCT on one audio segment, the encoder side obtains one spectrum. The spectrum includes N frequencies. xᵢ represents a time-domain audio signal before windowing, and wᵢ represents a window function used to perform windowing on xᵢ. xᵢ corresponds to an i^{th} sampling point in an audio segment, and Xₖ represents a k^{th} frequency value in a spectrum corresponding to the audio segment. It can be learned from Formula (1) and Formula (2) that MDCT transforms time domain data with a length of 2N to frequency domain data with a length of N. That is, MDCT enables time-domain aliasing of the audio signal.

A transform principle of DCT-IV is Formula (3):

$${X}_{k} = {\sum }_{i = 0}^{N - 1} {x}_{i} cos [ \frac{π}{N} ( i + \frac{1}{2} ) ( k + \frac{1}{2} ) ] , k = 0 , … , N - 1 \qquad ( 3 )$$

It can be learned from Formula (3) that, DCT-IV is to transform time-domain data with a length of N to frequency-domain data with a length of N. That is, DCT-IV is time-frequency transform from N to N.

Based on a periodicity or symmetry of a cosine function, transform may be performed based on Formula (4):

$$\begin{matrix}cos [ \frac{π}{N} ( - n - 1 + \frac{1}{2} ) ( k + \frac{1}{2} ) ] = cos [ \frac{π}{N} ( n + \frac{1}{2} ) ( k + \frac{1}{2} ) ] \\ = - cos [ \frac{π}{N} ( 2 N - n - 1 + \frac{1}{2} ) ( k + \frac{1}{2} ) ]\end{matrix} \qquad ( 4 )$$

If data with a length of 2N in MDCT is divided into two adjacent frames with a length of N, and each frame is equally divided into two parts, four pieces of data a, b, c, and d with a length of N/2 can be obtained. Formula (1) is unfolded into two data transform forms with a length of N, and then unfolded Formula (1) is represented in a form of Formula (3) based on the symmetry in Formula (4), to obtain a folding relationship shown in Formula (5), and obtain a transform relationship shown in Formula (6):

$$a , b , c , d \to - {c}_{R} - d , a - {b}_{R} \qquad ( 5 )$$

$$MDCT ( a , b , c , d ) = DCT - IV ( - {c}_{R} - d , a - {b}_{R} ) \qquad ( 6 )$$

R represents taking a reverse order of a sequence, or data reversing (reverse).

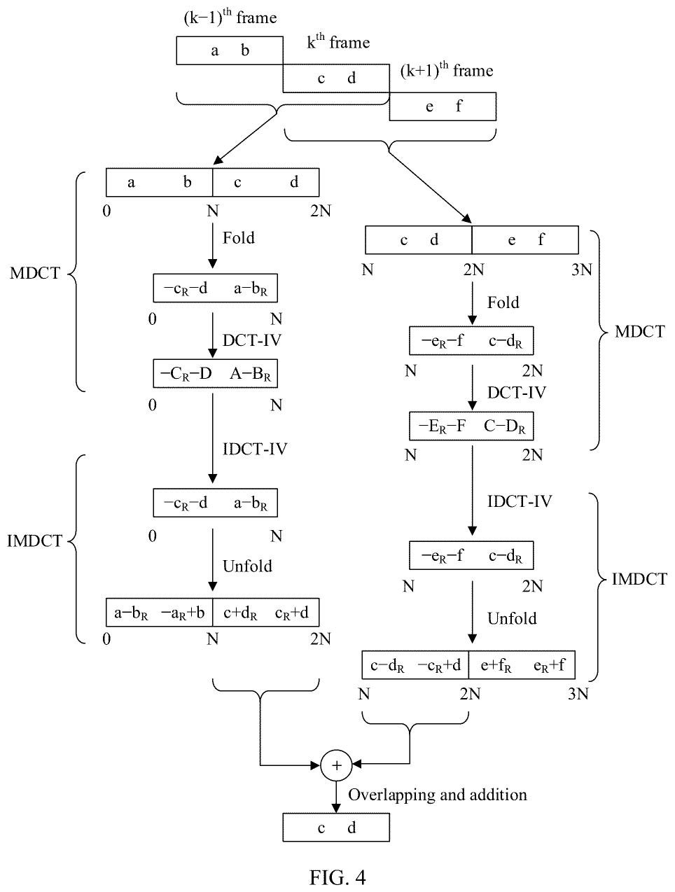

The following shows an MDCT process in FIG. 4. As shown in FIG. 4, each audio frame (whose length is N) is equally divided into two parts. For example, a (k−1)^{th} frame is equally divided into two parts of data: a and b, a k^{th} frame is equally divided into two parts of data: c and d, and a (k+1)^{th} frame is equally divided into two parts of data: e and f. A process in which the encoder side performs a specific time of MDCT is as follows: folding data [a, b, c, d] whose lengths are 2N in the (k−1)^{th} frame and the k^{th} frame, to obtain data [−c_{R}−d, a−b_{R}] whose lengths are N. Then, DCT-IV transform is performed on the data [−c_{R}−d, a−b_{R}], to obtain data [−C_{R}−D, A−B_{R}] whose length is N, that is, obtain a spectrum. Similarly, a process in which the encoder side performs a next time of MDCT is as follows: folding data [c, d, e, f] whose lengths are 2N in the k^{th} frame and the (k+1)^{th} frame, to obtain data [−e_{R}−f, c−d_{R}] whose lengths are N. Then, DCT-IV transform is performed on the data [−e_{R}−f, c−d_{R}], to obtain data [−E_{R}−F, C−D_{R}] whose length is N, that is, obtain a next spectrum.

After parsing out the plurality of spectrums from a bitstream and performing dequantization, a decoder side performs MDCT inverse transform (inverse-MDCT, IMDCT) on the plurality of dequantized spectrums based on Formula (7), to obtain a plurality of windowed time-domain signals. Subsequently, dewindowing processing further needs to be performed on the plurality of time-domain signals based on a window function, to obtain a plurality of dewindowed time-domain signals. Because MDCT performed by the encoder side enables time-domain aliasing of the audio signal, after obtaining the plurality of dewindowed time-domain signals, the decoder side further performs overlapping and addition on the plurality of time-domain signals, to obtain a reconstructed audio signal. IDMCT is first described herein.

$${x}_{i} = \frac{1}{N} {\sum }_{K = 0}^{N - 1} {X}_{k} cos [ \frac{π}{N} ( i + \frac{1}{2} + \frac{N}{2} ) ( k + \frac{1}{2} ) ] , i = 0 , ... , 2 N - 1 \qquad ( 7 )$$

Refer to Formula (7). One audio frame includes N sampling points, every two adjacent audio frames form one audio segment, and one audio segment includes 2N sampling points. Xₖ represents a k^{th} frequency value in a dequantized spectrum corresponding to an audio segment, and the dequantized spectrum corresponding to the audio segment includes N frequencies. xᵢ indicates an i^{th} sampling point in 2N sampling points obtained through IMDCT, and xᵢ is a windowed signal. It can be learned from Formula (7) that IMDCT is to inversely transform frequency domain data with a length of N to time domain data with a length of 2N.

FIG. 4 also shows an IMDCT process. As shown in FIG. 4, a process in which the decoder side performs a specific time of IMDCT includes: performing DCT-IV inverse transform on data [−C_{R}−D, A−B_{R}] whose lengths are N, to obtain data [−c_{R}−d, a−b_{R}] whose lengths are N, and then unfolding the data [−c_{R}−d, a−b_{R}], to obtain four parts of data [a−b_{R}, −a_{R}+b, c+d_{R}, c_{R}+d] whose lengths are 2N. a−b_{R} and −a_{R}+b are mutually odd symmetric, and c+d_{R} and c_{R}+d are mutually even symmetric. Similarly, a process in which the decoder side performs a next time of IMDCT includes: performing DCT-IV inverse transform (IDCT-IV) on data [−E_{R}−F, C−D_{R}] whose lengths are N, to obtain data [−e_{R}−f, c−d_{R}] whose lengths are N, and then unfolding the data −e_{R}−f, c−d_{R}], to obtain four parts of data [c−d_{R}, −c_{R}+d, e+f_{R}, e_{R}+f] whose lengths are 2N. A process of a first time of IMDCT is shown in Formula (8), and a process of a second time of IMDCT is shown in Formula (9).

$$IMDCT ( MDCT ( a , b , c , d ) ) = a - {b}_{R} , - {a}_{R} + b , c + {d}_{R} , {c}_{R} + d \qquad ( 8 )$$

$$IMDCT ( MDCT ( c , d , e , f ) ) = c - {d}_{R} , - {c}_{R} + d , e + {f}_{R} , {f}_{R} + e \qquad ( 9 )$$

As shown in FIG. 4, the decoder side performs overlapping and addition on a second half part (namely, c+d_{R}, c_{R}+d) of the data [a−b_{R}, −a_{R}+b, c+d_{R}, c_{R}+d] and a first half part (namely, c−d_{R}, −c_{R}+d) of the data [c−d_{R}, −c_{R}+d, e+f_{R}, e_{R}+f], to restore the two parts of data c and d, that is, reconstruct a 2^{nd} audio frame. It can be learned that, in the overlapping and addition manner, the decoder side can restore the 2^{nd} frame of signal when a 3rd frame of data is input.

It should be noted that, in FIG. 4, a process in which the encoder side performs windowing and a process in which the decoder side performs dewindowing are omitted. FIG. 4 does not show the process in which the encoder side performs windowing and the process in which the decoder side performs dewindowing, which does not indicate that windowing and dewindowing do not need to be performed in an encoding and decoding process.

The window function used in embodiments of the present disclosure meets a basic folding property of MDCT. This is described below.

It can be learned from the foregoing related descriptions of MDCT that MDCT meets Formula (6), and with reference to Formula (2) and Formula (6), Formula (10) can be obtained:

$$MDCT ( {w}_{1} a , {w}_{2} b , {w}_{3} c , {w}_{4} d ) \text{} = DCT 4 ( - {( {w}_{3} c )}_{R} - ( {w}_{4} d ) , ( {w}_{1} a ) - {( {w}_{2} b )}_{R} ) \qquad ( 10 )$$

In Formula (10), w₁, w₂, w₃, and w₄ represent four segments whose lengths are N/2 and that are obtained by evenly divide a window function whose length is 2N, and multiplication in Formula (10) represents multiplication of the window function and a corresponding point in PCM.

With reference to Formula (10), Formula (8), and Formula (9), Formula (11) and Formula (12) can be obtained:

$$IMDCT ( MDCT ( {w}_{1} a , {w}_{2} b , {w}_{3} c , {w}_{4} d ) ) = ( {Rw}_{4} ( \text{} ( {w}_{1} \text{} a ) - \text{} {( {w}_{2} b )}_{R} ) , \text{} {Rw}_{3} ( \text{} ( {w}_{2} \text{} b ) - {( {w}_{1} a )}_{R} ) , \text{} {Rw}_{2} ( \text{} {( {w}_{4} d )}_{R} + \text{} ( {w}_{3} \text{} c ) ) , \text{} {Rw}_{1} ( \text{} {( {w}_{3} c )}_{R} + ( {w}_{4} d ) ) \qquad ( 11 )$$

$$IMDCT ( MDCT ( {w}_{1} c , {w}_{2} d , {w}_{3} e , {w}_{4} f ) ) = ( {Rw}_{4} ( \text{} ( {w}_{1} \text{} c ) - \text{} {( {w}_{2} d )}_{R} ) , \text{} {Rw}_{3} ( \text{} ( {w}_{2} \text{} d ) - {( {w}_{1} c )}_{R} ) , \text{} {Rw}_{2} ( \text{} {( {w}_{4} f )}_{R} + \text{} ( {w}_{3} \text{} e ) ) , \text{} {Rw}_{1} ( \text{} {( {w}_{3} e )}_{R} + ( {w}_{4} f ) ) \qquad ( 12 )$$

To reconstruct c and d, a third term Rw₂((w₄d)_{R}+(w₃c)) in Formula (11) and a first term Rw₄((w₁c)−(w₂d)_{R}) in Formula (12) are added to be equal to c, and a fourth term Rw₁((w₃c)_{R}+(w₄d)) in Formula (7) and a second term Rw₃((w₂d)−(w₁c)_{R}) in Formula (12) are added to be equal to d, so that Formula (13) can be obtained:

$${Sw}_{3} * {Rw}_{2} + {Rw}_{4} * {Sw}_{1} = 1 \qquad ( 13 )$$

In Formula (13), S means taking a forward order of a sequence.

Formula (13) is a condition that needs to be satisfied by the window function. Regardless of whether the window function is symmetric, whether the window function is applied to lossy encoding or lossless coding, or whether the window function is a low-delay window, Formula (13) needs to be satisfied.

In addition, Formula (10) may also be represented as Formula (14):

$$MDCT ( {w}_{1} a , {w}_{2} b , {w}_{3} c , {w}_{4} d ) \text{} = DCT 4 ( RN ( - R ( {w}_{1} a ) - S ( {w}_{2} b ) , S ( {w}_{3} c ) + R ( {w}_{4} d ) ) ) \qquad ( 14 )$$

In Formula (14), N means taking a negative form of a sequence.

It is assumed that c and d are current frame inputs, and a and b are previous frames. The current frames c and d need to be processed into S(w₃c)+R(w₄d), and an input of DCT-IV is formed with reference to −R(w₁a)+S(w₂b) in a previous frame. Similarly, the current frames c and d further need to be processed into −R(w₁c)+S(w₂d) as some inputs of a next frame. Therefore, for the current frame, after a windowing and folding process is performed on the current frame, two parts are output, and are S(w₃c)+R(w₄d) and −R(w₁c)+S(w₂d). A first part is used for the current frame, and the second part is used for the next frame. In this case, the two parts output by the current frame may be expressed as Formula (15):

$$( \begin{matrix}S ( {w}_{3} c ) + R ( {w}_{4} d ) \\ - R ( {w}_{1} c ) + S ( {w}_{2} d )\end{matrix} ) = ( \begin{matrix}S & 0 \\ 0 & R\end{matrix} ) ( \begin{matrix}{Sw}_{3} & {Rw}_{4} \\ - {Sw}_{1} & {Rw}_{2}\end{matrix} ) ( \begin{matrix}S & 0 \\ 0 & R\end{matrix} ) ( \begin{matrix}c \\ d\end{matrix} ) \qquad ( 15 )$$

Because INTMDCT is lossless transform, for lossless encoding and decoding, the windowing and folding process needs to be completely digitally reversible, and therefore, needs to be implemented through decomposition of a lifting (Lifting) matrix shown in Formula (16):

$$( \begin{matrix}P & W \\ G & T\end{matrix} ) = ( \begin{matrix}1 & \frac{P - 1}{G} \\ 0 & 1\end{matrix} ) ( \begin{matrix}1 & 0 \\ G & 1\end{matrix} ) ( \begin{matrix}1 & \frac{T - 1}{G} \\ 0 & 1\end{matrix} ) \qquad ( 16 )$$

The lifting matrix shown in Formula (16) meets a decomposition condition: a determinant is 1, that is, PT−WG=1, and W, G≠0.

A second matrix in Formula (15) is represented by using the lifting matrix shown in Formula (16), and Formula (17) may be obtained:

$$( \begin{matrix}S ( {w}_{3} c ) + R ( {w}_{4} d ) \\ - R ( {w}_{1} c ) + S ( {w}_{2} d )\end{matrix} ) = ( \begin{matrix}S & 0 \\ 0 & R\end{matrix} ) ( \begin{matrix}1 & \frac{{Sw}_{3} - 1}{- {Sw}_{1}} \\ 0 & 1\end{matrix} ) ( \begin{matrix}1 & 0 \\ - {Sw}_{1} & 1\end{matrix} ) ( \begin{matrix}1 & \frac{{Rw}_{2} - 1}{- {Sw}_{1}} \\ 0 & 1\end{matrix} ) ( \begin{matrix}S & 0 \\ 0 & R\end{matrix} ) ( \begin{matrix}c \\ d\end{matrix} ) \qquad ( 17 )$$

It is determined, based on Formula (17), that a windowing and folding matrix for INTMDCT performed on the audio frame is shown in Formula (18):

$$F 1 = ( \begin{matrix}S & 0 \\ 0 & R\end{matrix} ) ( \begin{matrix}1 & \frac{{Sw}_{3} - 1}{- {Sw}_{1}} \\ 0 & 1\end{matrix} ) ( \begin{matrix}1 & 0 \\ - {Sw}_{1} & 1\end{matrix} ) ( \begin{matrix}1 & \frac{{Rw}_{2} - 1}{- {Sw}_{1}} \\ 0 & 1\end{matrix} ) ( \begin{matrix}S & 0 \\ 0 & R\end{matrix} ) \qquad ( 18 )$$

In a non-low-delay scenario, Formula (13) meets the condition that the determinant of the lifting matrix is 1. Therefore, Formula (18) may be applied to the non-low-delay scenario.

In a low-delay scenario, an overlapping region of the window function meets Formula (13) and the decomposition condition of the lifting matrix, and a function value of the overlapping region is between 0 and 1. Therefore, regardless of a window type, values of the two formulas

$$\frac{{Sw}_{3} - 1}{- {Sw}_{1}} and \frac{{Rw}_{2} - 1}{- {Sw}_{1}}$$

are always stable, and do not include a maximum value or a minimum value. Formula (18) is applicable to the overlapping region in the low-delay scenario.

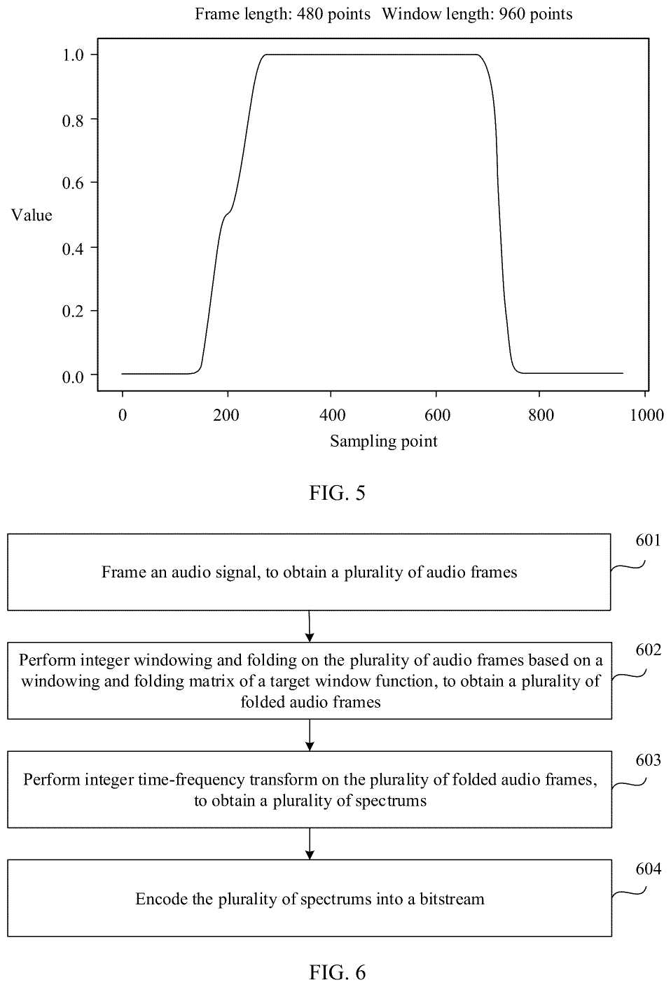

For example, a low-delay window function shown in FIG. 5 is used as an example. A length of the window function is 960 points, the 960 points are evenly classified into four segments: w1, w2, w3, and w4, w1 includes a point in an interval [0, 240), w2 includes a point in an interval [240, 480), w3 includes a point in an interval [480, 720), and w2 includes a point in an interval [720, 960). A non-overlapping part of w1 includes a point in an interval [0, 180), and an overlapping part includes a point in an interval [180, 240). An overlapping part of w2 includes a point in an interval [240, 300) and a non-overlapping part includes a point in an interval [300, 480). A non-overlapping part of w3 includes a point in an interval [480, 660), and an overlapping part includes a point in an interval [660, 720). An overlapping part of w4 includes a point in an interval [720, 780) and a non-overlapping part includes a point in an interval [780, 960). A function value of an overlapping part is between 0 and 1. Therefore, regardless of a window type, values of

$$\frac{{Sw}_{3} - 1}{- {Sw}_{1}} and \frac{{Rw}_{2} - 1}{- {Sw}_{1}}$$

are always stable, and do not include a maximum value or a minimum value. Formula (18) is applicable to the overlapping region in the low-delay scenario.

In the low-delay scenario, the window function has data of 0 at a tail. To be specific, a value of the non-overlapping region of w4 is 0. Therefore, to reconstruct c and d, Formula (13) may be regressed to Formula (19):

$${Sw}_{3} * {Rw}_{2} = 1 , {Rw}_{4} = 0 \qquad ( 19 )$$

Formula (19) shows a condition that is met by a non-overlapping region of the window function. Reconstruction of data corresponding to the non-overlapping region does not depend on data of a previous frame, for example, does not depend on some data obtained through windowing and folding in a previous frame. Therefore, a delay can be reduced. In this case, the lifting matrix does not meet the condition of W, G≠0.

Therefore, for the non-overlapping region, in a case of different window types, a function value of the window function may be equal to 0 or equal to 1. Therefore, stability of values of the two formulas

$$\frac{{Sw}_{3} - 1}{- {Sw}_{1}} and \frac{{Rw}_{2} - 1}{- {Sw}_{1}}$$

changes.

For a low-delay symmetric window function, and in the non-overlapping region, w₁ and w₄ are 0, and w₂ and w₃ are 1. In this case, Formula (17) may be represented by Formula (20):

$$( \begin{matrix}S ( {w}_{3} c ) + R ( {w}_{4} d ) \\ - R ( {w}_{1} c ) + S ( {w}_{2} d )\end{matrix} ) = ( \begin{matrix}S & 0 \\ 0 & R\end{matrix} ) ( \begin{matrix}1 & 0 \\ 0 & 1\end{matrix} ) ( \begin{matrix}1 & 0 \\ 0 & 1\end{matrix} ) ( \begin{matrix}1 & 0 \\ 0 & 1\end{matrix} ) ( \begin{matrix}S & 0 \\ 0 & R\end{matrix} ) ( \begin{matrix}c \\ d\end{matrix} ) \qquad ( 20 )$$

That is, a matrix multiplication result is the window function. For the low-delay symmetric window function, the window function is obtained by processing the overlapping region.

For a low-delay asymmetric window function, there are three possible cases:

$$w 1 \neq 0 , w 2 , w 3 = 1$$

$$w 1 = 0 , w 2 , w 3 \neq 1$$

$$w 1 \neq 0 , w 2 , w 3 \neq 1$$

In the three cases, Formula (17) may be represented by Formula (21), Formula (22), and Formula (23):

$$( \begin{matrix}S ( {w}_{3} c ) + R ( {w}_{4} d ) \\ - R ( {w}_{1} c ) + S ( {w}_{2} d )\end{matrix} ) = ( \begin{matrix}S & 0 \\ 0 & R\end{matrix} ) ( \begin{matrix}1 & 0 \\ 0 & 1\end{matrix} ) ( \begin{matrix}1 & 0 \\ - S {w}_{1} & 1\end{matrix} ) ( \begin{matrix}1 & 0 \\ 0 & 1\end{matrix} ) ( \begin{matrix}S & 0 \\ 0 & R\end{matrix} ) ( \begin{matrix}c \\ d\end{matrix} ) \qquad ( 21 )$$

$$( \begin{matrix}S ( {w}_{3} c ) + R ( {w}_{4} d ) \\ - R ( {w}_{1} c ) + S ( {w}_{2} d )\end{matrix} ) = ( \begin{matrix}S & 0 \\ 0 & R\end{matrix} ) ( \begin{matrix}1 & + ∞ \\ 0 & 1\end{matrix} ) ( \begin{matrix}1 & 0 \\ 0 & 1\end{matrix} ) ( \begin{matrix}1 & + ∞ \\ 0 & 1\end{matrix} ) ( \begin{matrix}S & 0 \\ 0 & R\end{matrix} ) ( \begin{matrix}c \\ d\end{matrix} ) \qquad ( 22 )$$

$$( \begin{matrix}S ( {w}_{3} c ) + R ( {w}_{4} d ) \\ - R ( {w}_{1} c ) + S ( {w}_{2} d )\end{matrix} ) = ( \begin{matrix}S & 0 \\ 0 & R\end{matrix} ) ( \begin{matrix}1 & \frac{{Sw}_{3} - 1}{- {Sw}_{1}} \\ 0 & 1\end{matrix} ) ( \begin{matrix}1 & 0 \\ - S {w}_{1} & 1\end{matrix} ) ( \begin{matrix}1 & \frac{{Rw}_{2} - 1}{- {Sw}_{1}} \\ 0 & 1\end{matrix} ) ( \begin{matrix}S & 0 \\ 0 & R\end{matrix} ) ( \begin{matrix}c \\ d\end{matrix} ) \qquad ( 23 )$$

Formula (21) is stable, and there is no maximum value or minimum value. Formula (18) is applicable. Formula (22) is unstable, and there is a maximum value. Formula (18) is not applicable. Formula (23) needs to be determined based on a calculation result, but is usually unstable in most cases because a maximum value is included due to division between minimum values. Formula (18) is applicable only when the values of the two formulas

$$\frac{S {w}_{3} - 1}{- S {w}_{1}} and \frac{R {w}_{2} - 1}{- S {w}_{1}}$$

are stable and do not overflow after corresponding points in the audio frame are multiplied.

Through the foregoing analysis, an embodiment of the present disclosure provides a universal INTMDCT transform manner. In an audio encoding and decoding process, the transform manner may be applied to a non-low-delay or low-delay window function and an asymmetric or symmetric window function. The following describes the method provided in embodiments of the present disclosure.

FIG. 6 is a flowchart of an audio encoding method according to an embodiment of the present disclosure. The audio encoding method is applied to an encoder side. As shown in FIG. 6, the audio encoding method includes the following steps.

Step 601: Frame an audio signal, to obtain a plurality of audio frames.

In this embodiment of the present disclosure, the encoder side frames the audio signal in any framing method, to obtain the plurality of audio frames. To be specific, the encoder side classifies sampling points included in the audio signal into the plurality of audio frames. Frame lengths of all audio frames are the same. In other words, quantities of sampling points included in all the audio frames are the same.

Optionally, frame lengths of the plurality of audio frames are 5 ms or 10 ms, or may be another frame length. A quantity of sampling points included in each audio frame is affected by a sampling rate and a frame length of the audio signal. For example, if the frame length is 10 ms, at a sampling rate of 48 kilohertz (kHz) and a sampling rate of 96 kHz, quantities of sampling points included in the audio frame are respectively 480 and 960.

Step 602: Perform integer windowing and folding on the plurality of audio frames based on a windowing and folding matrix of a target window function, to obtain a plurality of folded audio frames.

In some embodiments, the windowing and folding matrix of the target window function is as follows:

$$F 1 = ( \begin{matrix}S & 0 \\ 0 & R\end{matrix} ) ( \begin{matrix}1 & \frac{{Sw}_{3} - 1}{- {Sw}_{1}} \\ 0 & 1\end{matrix} ) ( \begin{matrix}1 & 0 \\ - S {w}_{1} & 1\end{matrix} ) ( \begin{matrix}1 & \frac{{Rw}_{2} - 1}{- {Sw}_{1}} \\ 0 & 1\end{matrix} ) ( \begin{matrix}S & 0 \\ 0 & R\end{matrix} ) .$$

S represents taking a forward order of a sequence, R represents taking a reverse order of a sequence, the target window function is evenly divided into four parts, w₁ represents a function value of a first part of the target window function, w₂ represents a function value of a second part of the target window function, and w₃ represents a function value of a third part of the target window function.

In a possible implementation, the target window function may be evenly divided into the four parts based on a window length of the target window function. In other words, the window length of the target window function is evenly divided into four parts, so that the target window function is evenly divided into the four parts. Quantities of function points included in the four parts are the same.

In this embodiment of the present disclosure, the target window function is divided into an overlapping region and a non-overlapping region, and the overlapping region and the non-overlapping region meet the following conditions:
(1) Both the overlapping region and the non-overlapping region meet Sw₃*Rw₂+Rw₄*Sw₁=1, where w₄ represents a function value of a fourth part of the target window function;
(2) w₄ in the non-overlapping region is 0; and
(3) w₁ in the non-overlapping region is not 0, and values of

$$\frac{S {w}_{3} - 1}{- S {w}_{1}} and \frac{R {w}_{2} - 1}{- S {w}_{1}}$$

in the non-overlapping region fall within a specified range.

That is, when the target window function meets the foregoing conditions, the windowing and folding matrix is applicable regardless of whether the target window function is a non-low-delay window function, a low-delay window function, an asymmetric window function, or a symmetric window function.

When the values of

$$\frac{S {w}_{3} - 1}{- S {w}_{1}} and \frac{R {w}_{2} - 1}{- S {w}_{1}}$$

in the non-overlapping region fall within the specified range, the values of

$$\frac{S {w}_{3} - 1}{- S {w}_{1}} and \frac{R {w}_{2} - 1}{- S {w}_{1}}$$

are not maximum values or minimum values. The maximum value may also be referred to as an infinite large value, and the minimum value may also be referred to as an infinite small value. This is not limited in this embodiment of the present disclosure.

The specified range is a data representation range. In some embodiments, the specified range is [−128, 128]. Certainly, a value of the specified range may vary with the data representation range.

In some embodiments, the target window function may be divided into the overlapping region and the non-overlapping region based on a related algorithm. For example, the quantity of sampling points of the audio frame is multiplied by delay information of the target window function, to obtain a total length of the overlapping region of the target window function in a sampling point range of the audio frame. A midpoint of the overlapping region in the sampling point range of the audio frame is a midpoint in the sampling points of the audio frame. The non-overlapping region and the overlapping region in the target window function are determined based on the total length of the overlapping region in the sampling point range of the audio frame and the midpoint of the overlapping region.

For example, there are 480 sampling points of the audio frame, and the window function shown in FIG. 5 is used as the target window function. A length of the target window function is 960 points, and the delay information of the target window function is ¼. The quantity of sampling points of the audio frame is multiplied by the delay information of the target window function, to learn that a total length of the overlapping region of the target window function in the sampling point range of the audio frame is 120 points. To be specific, a total length of the overlapping region in first 480 points of the target window function is 120 points, and a total length of the overlapping region in last 480 points of the target window function is 120 points. The midpoint of the overlapping region is a midpoint in the 480 points. Therefore, it is determined that the midpoint of the overlapping region in the first 480 points is a 240^{th} point, and a midpoint of the overlapping region in the last 480 points is a 720^{th} point. In this case, based on the total length of the overlapping region and the midpoint of the overlapping region in the first/last 480 points, it is determined that the non-overlapping region of the target window function is [0, 180), [300, 480), [480, 660), and [780, 960), and the overlapping region is [180, 240), [240, 300), [660, 720), and [720, 780).

Step 603: Perform integer time-frequency transform on the plurality of folded audio frames, to obtain a plurality of spectrums.

The integer time-frequency transform is to transform the plurality of folded audio frames in time domain into frequency domain data. That is, the plurality of spectrums are the frequency domain data. The integer time-frequency transform may be INTDCT transform, integer DCT-IV transform, or the like. This is not limited in this embodiment of the present disclosure.

Based on the foregoing descriptions, the plurality of spectrums are spectrums of an LR channel. In some cases, for example, when a sum of sub-band quantization scales determined by performing sub-band division on the spectrums of the LR channel is greater than a sum of quantization scales of an MS channel, INTMS channel transform may be further performed on the plurality of spectrums based on a channel transform matrix.

In some embodiments, the channel transform matrix is as follows:

$$H 1 = ( \begin{matrix}1 & \frac{cos θ 1 - 1}{sin θ 1} \\ 0 & 1\end{matrix} ) ( \begin{matrix}1 & 0 \\ sin θ 1 & 1\end{matrix} ) ( \begin{matrix}1 & \frac{cos θ 1 - 1}{sin θ 1} \\ 0 & 1\end{matrix} ) .$$

θ1 represents an angle of rotation of channel transform.

It should be noted that, θ1 is an angle of rotation specified based on the audio signal, for example, may be 45 degrees, and a value of θ1 may vary with a feature of the audio signal.

Step 604: Encode the plurality of spectrums into a bitstream.

After the plurality of spectrums are determined in step 603, if INTMS channel transform does not need to be performed on the plurality of spectrums, the plurality of spectrums may be directly encoded into the bitstream. If INTMS channel transform needs to be performed on the plurality of spectrums, the plurality of spectrums on which INTMS channel transform is performed may be encoded into the bitstream.

The windowing and folding matrix provided in this embodiment of the present disclosure can be applied to a non-low-delay or low-delay window function and an asymmetric or symmetric window function. After integer windowing and folding are performed on the audio frame based on the windowing and folding matrix, integer time-frequency transform is performed on the folded audio frame, to obtain integer spectrum data. That is, this embodiment of the present disclosure provides a universal INTMDCT transform method. In this method, integer spectrum data can be obtained after a time-domain audio frame is transformed, to implement lossless transform of audio data.

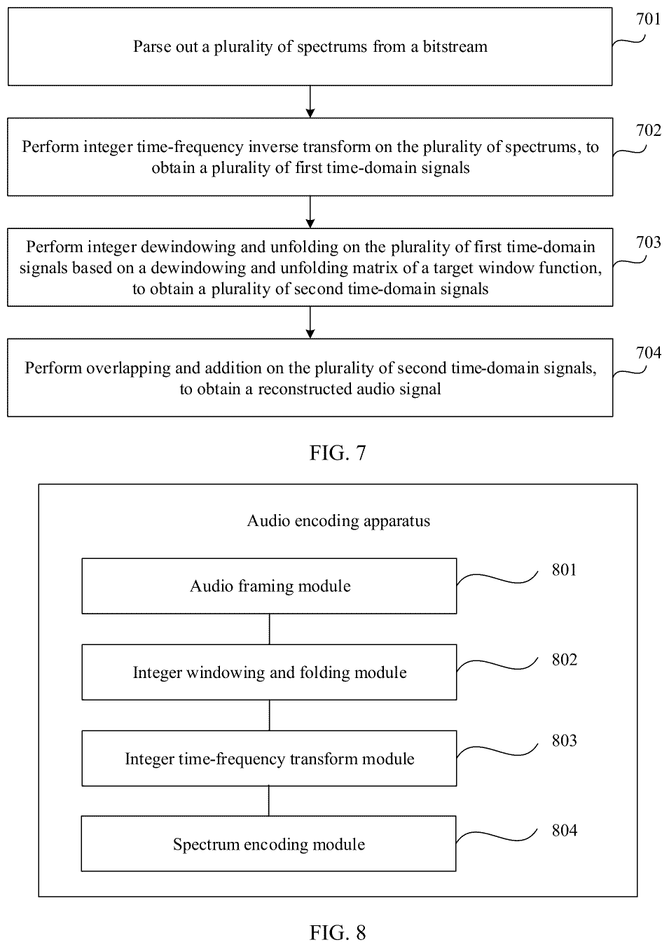

FIG. 7 is a flowchart of an audio decoding method according to an embodiment of the present disclosure. The audio decoding method is applied to a decoder side. As shown in FIG. 7, the audio decoding method includes the following steps.

Step 701: Parse out a plurality of spectrums from a bitstream.

In this embodiment of the present disclosure, the decoder side first parses out the plurality of spectrums from the bitstream.

It should be noted that, if an encoder side encodes a spectrum of an LR channel into a bitstream, the plurality of spectrums parsed out by the decoder side from the bitstream are spectrums of the LR channel. If the encoder side performs INTMS channel transform on the spectrum of the LR channel and then encodes the spectrum into the bitstream, the plurality of spectrums parsed out by the decoder side from the bitstream are spectrums obtained through INTMS channel transform.

Step 702: Perform integer time-frequency inverse transform on the plurality of spectrums, to obtain a plurality of first time-domain signals.

Integer time-frequency inverse transform used by a decoder side is inverse transform of integer time-frequency transform used by an encoder side. Integer time-frequency inverse transform used by the decoder side varies with integer time-frequency transform used by the encoder side. This is not limited in this embodiment of the present disclosure.

Based on the foregoing descriptions, the plurality of spectrums parsed out by the decoder side from the bitstream may be spectrums of the LR channel, or may be spectrums obtained through INTMS channel transform. When the plurality of spectrums are spectrums of the LR channel, the decoder side may directly perform integer time-frequency inverse transform on the plurality of spectrums, to obtain the plurality of first time-domain signals. When the plurality of spectrums are spectrums obtained through INTMS channel transform, before performing integer time-frequency inverse transform on the plurality of spectrums, the decoder side may further perform INTIMS channel transform on the plurality of spectrums based on a channel inverse transform matrix. Then, integer time-frequency inverse transform is performed, to obtain the plurality of first time-domain signals.

INTIMS channel transform used by the decoder side is inverse transform of INTMS channel transform used by the encoder side. An INTIMS channel transform manner used by the decoder side varies with an INTMS channel transform manner used by the encoder side. This is not limited in this embodiment of the present disclosure.

In some embodiments, the channel inverse transform matrix is as follows:

$$H 2 = ( \begin{matrix}1 & \frac{- ( cos θ 2 - 1 )}{sin θ 1} \\ 0 & 1\end{matrix} ) ( \begin{matrix}1 & 0 \\ - sin θ 2 & 1\end{matrix} ) ( \begin{matrix}1 & \frac{- ( cos θ 2 - 1}{sin θ 2} \\ 0 & 1\end{matrix} ) .$$

θ2 represents an angle of rotation of channel inverse transform.

It should be noted that, θ2 is an angle of rotation specified based on the audio signal, for example, may be −45 degrees, and a value of θ2 may vary with a feature of the audio signal. In addition, a value of θ2 and a value of θ1 used by the encoder side may be symmetric, to be specific, have a same absolute value and opposite signs.

Step 703: Perform integer dewindowing and unfolding on the plurality of first time-domain signals based on a dewindowing and unfolding matrix of a target window function, to obtain a plurality of second time-domain signals.

In some embodiments, the dewindowing and unfolding matrix of the target window function is as follows:

$$F 2 = ( \begin{matrix}S & 0 \\ 0 & R\end{matrix} ) ( \begin{matrix}1 & \frac{{Sw}_{3} - 1}{{Sw}_{1}} \\ 0 & 1\end{matrix} ) ( \begin{matrix}1 & 0 \\ S {w}_{1} & 1\end{matrix} ) ( \begin{matrix}1 & \frac{{Rw}_{2} - 1}{{Sw}_{1}} \\ 0 & 1\end{matrix} ) ( \begin{matrix}S & 0 \\ 0 & R\end{matrix} ) .$$

S represents taking a forward order of a sequence, R represents taking a reverse order of a sequence, the target window function is evenly divided into four parts, w₁ represents a function value of a first part of the target window function, w₂ represents a function value of a second part of the target window function, and w₃ represents a function value of a third part of the target window function.

In a possible implementation, the target window function may be evenly divided into the four parts based on a window length of the target window function. In other words, the window length of the target window function is evenly divided into four parts, so that the target window function is evenly divided into the four parts. Quantities of function points included in the four parts are the same.

In this embodiment of the present disclosure, the target window function is divided into an overlapping region and a non-overlapping region, and the overlapping region and the non-overlapping region meet the following conditions:
(1) Both the overlapping region and the non-overlapping region meet Sw₃*Rw₂+Rw₄*Sw₁=1, where w₄ represents a function value of a fourth part of the target window function;
(2) w₄ in the non-overlapping region is 0; and
(3) w₁ in the non-overlapping region is not 0, and values of

$$\frac{S {w}_{3} - 1}{- S {w}_{1}} and \frac{R {w}_{2} - 1}{- S {w}_{1}}$$

in the non-overlapping region fall within a specified range.

That is, when the target window function meets the foregoing conditions, the dewindowing and unfolding matrix is applicable regardless of whether the target window function is a non-low-delay window function, a low-delay window function, an asymmetric window function, or a symmetric window function.

When the values of

$$\frac{S {w}_{3} - 1}{- S {w}_{1}} and \frac{R {w}_{2} - 1}{- S {w}_{1}}$$

in the non-overlapping region fall within the specified range, the values of

$$\frac{S {w}_{3} - 1}{- S {w}_{1}} and \frac{R {w}_{2} - 1}{- S {w}_{1}}$$

are not maximum values or minimum values. The maximum value may also be referred to as an infinite large value, and the minimum value may also be referred to as an infinite small value. This is not limited in this embodiment of the present disclosure.

The specified range is a data representation range. In some embodiments, the specified range is [−128, 128]. Certainly, a value of the specified range may vary with the data representation range.

A method for dividing the target window function into the overlapping region and the non-overlapping region is the same as the method on the encoder side. For a detailed implementation process, refer to related content on the encoder side. Details are not described herein again.

Step 704: Perform overlapping and addition on the plurality of second time-domain signals, to obtain a reconstructed audio signal.

In this embodiment of the present disclosure, the decoder side performs overlapping and addition on the plurality of second time-domain signals, to obtain the reconstructed audio signal. The reconstructed audio signal may be used for playback.

The dewindowing and unfolding matrix provided in this embodiment of the present disclosure can be applied to a non-low-delay or low-delay window function and an asymmetric or symmetric window function. After integer dewindowing and unfolding are performed, based on the dewindowing and unfolding matrix, on a time domain signal obtained through integer time-frequency inverse transform, integer time domain data can be obtained. That is, this embodiment of the present disclosure provides a universal INTIMDCT transform method. According to the method, integer time domain data can be obtained after frequency domain data is transformed, to implement lossless inverse transform of audio data.

FIG. 8 is a diagram of a structure of an audio encoding apparatus according to an embodiment of the present disclosure. The audio encoding apparatus may be implemented as a part or all of an audio encoding device by using software, hardware, or a combination thereof. The audio encoding device may be the foregoing encoder side. As shown in FIG. 8, the apparatus includes an audio framing module 801, an integer windowing and folding module 802, an integer time-frequency transform module 803, and a spectrum encoding module 804.

The audio framing module 801 is configured to frame an audio signal, to obtain a plurality of audio frames. For a detailed implementation process, refer to related content in the embodiment shown in FIG. 6. Details are not described herein again.

The integer windowing and folding module 802 is configured to perform integer windowing and folding on the plurality of audio frames based on a windowing and folding matrix of a target window function, to obtain a plurality of folded audio frames. For a detailed implementation process, refer to related content in the embodiment shown in FIG. 6. Details are not described herein again.

The integer time-frequency transform module 803 is configured to perform integer time-frequency transform on the plurality of folded audio frames, to obtain a plurality of spectrums. For a detailed implementation process, refer to related content in the embodiment shown in FIG. 6. Details are not described herein again.

The spectrum encoding module 804 is configured to encode the plurality of spectrums into a bitstream. For a detailed implementation process, refer to related content in the embodiment shown in FIG. 6. Details are not described herein again.

Optionally, the windowing and folding matrix is as follows:

$$F 1 = ( \begin{matrix}S & 0 \\ 0 & R\end{matrix} ) ( \begin{matrix}1 & \frac{{Sw}_{3} - 1}{- {Sw}_{1}} \\ 0 & 1\end{matrix} ) ( \begin{matrix}1 & 0 \\ - S {w}_{1} & 1\end{matrix} ) ( \begin{matrix}1 & \frac{{Rw}_{2} - 1}{- {Sw}_{1}} \\ 0 & 1\end{matrix} ) ( \begin{matrix}S & 0 \\ 0 & R\end{matrix} ) .$$

S represents taking a forward order of a sequence, R represents taking a reverse order of a sequence, the target window function is evenly divided into four parts, w₁ represents a function value of a first part of the target window function, w₂ represents a function value of a second part of the target window function, and w₃ represents a function value of a third part of the target window function.

Optionally, the target window function is divided into an overlapping region and a non-overlapping region, and the overlapping region and the non-overlapping region meet the following conditions:
both the overlapping region and the non-overlapping region meet Sw₃*Rw₂+Rw₄*Sw₁=1, where w₄ represents a function value of a fourth part of the target window function;
w₄ in the non-overlapping region is 0; and
w₁ in the non-overlapping region is not 0, and values of

$$\frac{{Sw}_{3} - 1}{- {Sw}_{1}} and \frac{{Rw}_{2} - 1}{- {Sw}_{1}}$$

in the non-overlapping region fall within a specified range.

Optionally, the specified range is [−128, 128].

Optionally, the apparatus further includes:
a channel transform module, configured to perform integer mid/side INTMS channel transform on the plurality of spectrums based on a channel transform matrix.

The spectrum encoding module is configured to encode the plurality of spectrums on which INTMS channel transform is performed into the bitstream.

Optionally, the channel transform matrix is as follows:

$$H 1 = ( \begin{matrix}1 & \frac{cos θ 1 - 1}{sin θ 1} \\ 0 & 1\end{matrix} ) ( \begin{matrix}1 & 0 \\ sin θ 1 & 1\end{matrix} ) ( \begin{matrix}1 & \frac{cos θ 1 - 1}{sin θ 1} \\ 0 & 1\end{matrix} ) .$$

θ1 represents an angle of rotation of channel transform.

The windowing and folding matrix provided in this embodiment of the present disclosure can be applied to a non-low-delay or low-delay window function and an asymmetric or symmetric window function. After integer windowing and folding are performed on the audio frame based on the windowing and folding matrix, integer time-frequency transform is performed on the folded audio frame, to obtain integer spectrum data. That is, this embodiment of the present disclosure provides a universal INTMDCT transform method. In this method, integer spectrum data can be obtained after a time-domain audio frame is transformed, to implement lossless transform of audio data.

It should be noted that, when the audio encoding apparatus provided in the foregoing embodiment performs video encoding, division into the foregoing functional modules is merely used as an example for description. During actual application, the foregoing functions may be allocated to different functional modules for implementation according to a requirement. In other words, an internal structure of the apparatus is divided into different functional modules to implement all or some of the functions described above. In addition, the audio encoding apparatus provided in the foregoing embodiment and the audio encoding method embodiment belong to a same concept. For a specific implementation process of the audio encoding apparatus and the audio encoding method, refer to the method embodiment. Details are not described herein again.

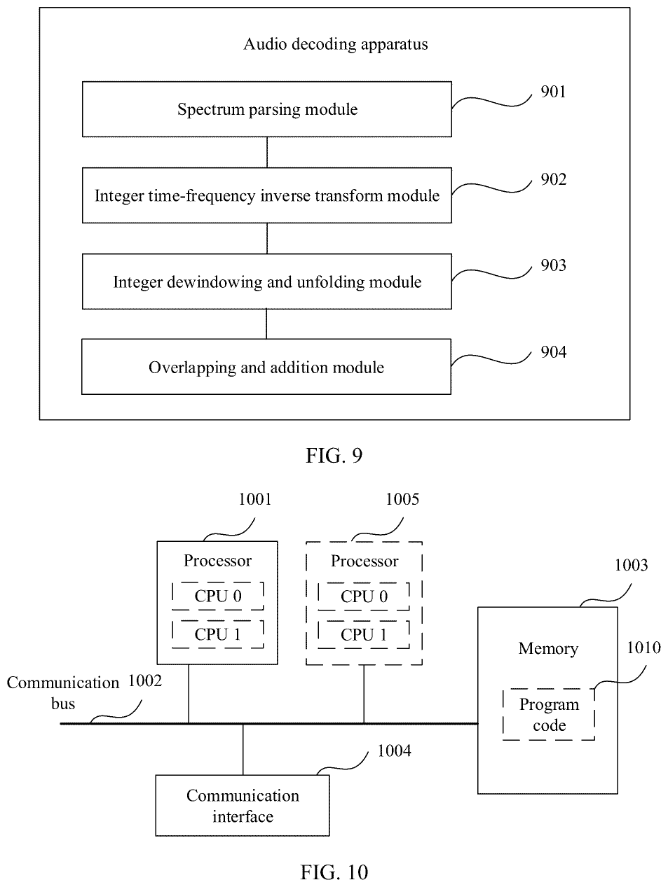

FIG. 9 is a diagram of a structure of an audio decoding apparatus according to an embodiment of the present disclosure. The audio decoding apparatus may be implemented as a part or all of an audio decoding device by using software, hardware, or a combination thereof. The audio decoding device may be the foregoing decoder side. As shown in FIG. 9, the apparatus includes a spectrum parsing module 901, an integer time-frequency inverse transform module 902, an integer dewindowing and unfolding module 903, and an overlapping and addition module 904.

The spectrum parsing module 901 is configured to parse out a plurality of spectrums from a bitstream.

The integer time-frequency inverse transform module 902 is configured to perform integer time-frequency inverse transform on the plurality of spectrums, to obtain a plurality of first time-domain signals.

The integer dewindowing and unfolding module 903 is configured to perform integer dewindowing and unfolding on the plurality of first time-domain signals based on a dewindowing and unfolding matrix of a target window function, to obtain a plurality of second time-domain signals.

The overlapping and addition module 904 is configured to perform overlapping and addition on the plurality of second time-domain signals, to obtain a reconstructed audio signal.

Optionally, the dewindowing and unfolding matrix is as follows:

$$F 2 = ( \begin{matrix}S & 0 \\ 0 & R\end{matrix} ) ( \begin{matrix}1 & \frac{{Sw}_{3} - 1}{{Sw}_{1}} \\ 0 & 1\end{matrix} ) ( \begin{matrix}1 & 0 \\ {Sw}_{1} & 1\end{matrix} ) ( \begin{matrix}1 & \frac{{Rw}_{2} - 1}{{Sw}_{1}} \\ 0 & 1\end{matrix} ) ( \begin{matrix}S & 0 \\ 0 & R\end{matrix} ) .$$

S represents taking a forward order of a sequence, R represents taking a reverse order of a sequence, the target window function is evenly divided into four parts, w₁ represents a function value of a first part of the target window function, w₂ represents a function value of a second part of the target window function, and w₃ represents a function value of a third part of the target window function.

Optionally, the target window function is divided into an overlapping region and a non-overlapping region, and the overlapping region and the non-overlapping region meet the following conditions:
both the overlapping region and the non-overlapping region meet Sw₃*Rw₂+Rw₄*Sw₁=1, where w₄ represents a function value of a fourth part of the target window function;
w₄ in the non-overlapping region is 0; and
w₁ in the non-overlapping region is not 0, and values of

$$\frac{{Sw}_{3} - 1}{- {Sw}_{1}} and \frac{{Rw}_{2} - 1}{- {Sw}_{1}}$$

in the non-overlapping region fall within a specified range.

Optionally, the specified range is [−128, 128].

Optionally, the apparatus further includes:
a channel inverse transform module, configured to perform integer inverse mid/side INTIMS channel transform on the plurality of spectrums based on a channel inverse transform matrix; and
an integer time-frequency inverse transform module, specifically configured to perform integer time-frequency inverse transform on the plurality of spectrums on which INTIMS channel transform is performed, to obtain the plurality of first time-domain signals.

Optionally, the channel inverse transform matrix is as follows:

$$H 2 = ( \begin{matrix}1 & \frac{- ( cos θ 2 - 1 )}{sin θ 2} \\ 0 & 1\end{matrix} ) ( \begin{matrix}1 & 0 \\ - sin θ 2 & 1\end{matrix} ) ( \begin{matrix}1 & \frac{- ( cos θ 2 - 1 )}{sin θ 2} \\ 0 & 1\end{matrix} ) .$$

θ2 represents an angle of rotation of channel inverse transform.

The dewindowing and unfolding matrix provided in this embodiment of the present disclosure can be applied to a non-low-delay or low-delay window function and an asymmetric or symmetric window function. After integer dewindowing and unfolding are performed, based on the dewindowing and unfolding matrix, on a time domain signal obtained through integer time-frequency inverse transform, integer time domain data can be obtained. That is, this embodiment of the present disclosure provides a universal INTIMDCT transform method. According to the method, integer time domain data can be obtained after frequency domain data is transformed, to implement lossless inverse transform of audio data.

It should be noted that, when the audio decoding apparatus provided in the foregoing embodiment performs video decoding, division into the foregoing functional modules is merely used as an example for description. During actual application, the foregoing functions may be allocated to different functional modules for implementation according to a requirement. In other words, an internal structure of the apparatus is divided into different functional modules to implement all or some of the functions described above. In addition, the audio decoding apparatus provided in the foregoing embodiment and the audio decoding method embodiment belong to a same concept. For a specific implementation process of the audio decoding apparatus and the audio decoding method, refer to the method embodiment. Details are not described herein again.

FIG. 10 is a diagram of a structure of an electronic device according to an embodiment of the present disclosure. Optionally, the electronic device may be the foregoing audio encoding device or audio decoding device. The electronic device includes one or more processors 1001, a communication bus 1002, a memory 1003, and one or more communication interfaces 1004.

The processor 1001 is a general-purpose central processing unit (CPU), a network processor (NP), a microprocessor, or one or more integrated circuits configured to implement the solutions of the present disclosure, for example, an application-specific integrated circuit (ASIC), a programmable logic device (PLD), or a combination thereof. Optionally, the PLD is a complex programmable logic device (PLD), a field-programmable gate array (FPGA), generic array logic (GAL), or any combination thereof.

The communication bus 1002 is configured to transfer information between the foregoing components. Optionally, the communication bus 1002 may be classified into an address bus, a data bus, a control bus, or the like. For ease of representation, only one bold line is used for indication in the figure, but it does not indicate that there is only one bus or only one type of bus.

Optionally, the memory 1003 is a read-only memory (ROM), a random access memory (RAM), an electrically erasable programmable read-only memory (EEPROM), an optical disc (including a compact disc read-only memory (CD-ROM), a compact disc, a laser disc, a digital versatile disc, a Blu-ray disc, and the like), a magnetic disk storage medium, another magnetic storage device, or any other medium that can be used to carry or store expected program code in a form of instructions or a data structure and that can be accessed by a computer, but is not limited thereto. The memory 1003 exists independently, and is connected to the processor 1001 through the communication bus 1002, or the memory 1003 is integrated with the processor 1001.

The communication interface 1004 is configured to communicate with another device or a communication network by using any apparatus like a transceiver. The communication interface 1004 includes a wired communication interface, and optionally, further includes a wireless communication interface. The wired communication interface is, for example, an Ethernet interface. Optionally, the Ethernet interface is an optical interface, an electrical interface, or a combination thereof. The wireless communication interface is a wireless local area network (WLAN) interface, a cellular network communication interface, a combination thereof, or the like.

Optionally, in some embodiments, the electronic device includes a plurality of processors, for example, the processor 1001 and a processor 1005 shown in FIG. 10. Each of these processors is a single-core processor or a multi-core processor. Optionally, the processor herein is one or more devices, circuits, and/or processing cores for processing data (for example, computer program instructions).

During specific implementation, in an embodiment, the electronic device further includes an output device 1006 and an input device 1007. The output device 1006 communicates with the processor 1001, and can display information in a plurality of manners. For example, the output device 1006 is a liquid crystal display (LCD), a light emitting diode (LED) display device, a cathode ray tube (CRT) display device, a projector, or the like. The input device 1007 communicates with the processor 1001, and can receive an input of a user in a plurality of manners. For example, the input device 1007 is a mouse, a keyboard, a touchscreen device, or a sensor device.

In some embodiments, the memory 1003 is configured to store program code 1010 for performing the solutions of the present disclosure, and the processor 1001 may execute the program code 1010 stored in the memory 1003. The program code includes one or more software modules, and the electronic device can implement, by using the processor 1001 and the program code 1010 in the memory 1003, the audio signal processing method provided in the following embodiment in FIG. 6 or FIG. 7.

An embodiment of the present disclosure further provides a computer-readable storage medium. The storage medium stores instructions, and when the instructions run on a computer, the computer is enabled to perform the audio encoding method or the audio decoding method.

An embodiment of the present disclosure further provides a computer program product including instructions. When the instructions run on a computer, the computer is enabled to perform the audio encoding method or the audio decoding method. In other words, a computer program is provided. When the computer program runs on a computer, the computer is enabled to perform the audio encoding method or audio decoding method.

All or some of the foregoing embodiments may be implemented by software, hardware, firmware, or any combination thereof. When software is used to implement the embodiments, all or a part of the embodiments may be implemented in a form of a computer program product. The computer program product includes one or more computer instructions. When the computer instructions are loaded and executed on the computer, the procedure or functions according to the embodiments of the present disclosure are all or partially generated. The computer may be a general-purpose computer, a dedicated computer, a computer network, or another programmable apparatus. The computer instructions may be stored in a computer-readable storage medium or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk drive, or a magnetic tape), an optical medium (for example, a digital versatile disc (DVD)), a semiconductor medium (for example, a solid state disk (SSD)), or the like. It should be noted that the computer-readable storage medium mentioned in embodiments of the present disclosure may be a non-volatile storage medium, that is, may be a non-transitory storage medium.

It should be understood that “a plurality of” in this specification means two or more. In descriptions of embodiments of the present disclosure, “/” means “or” unless otherwise specified. For example, A/B may indicate A or B. In this specification, “and/or” merely describes an association relationship between associated objects and indicates that three relationships may exist. For example, A and/or B may indicate the following three cases: Only A exists, both A and B exist, and only B exists. In addition, to clearly describe technical solutions in embodiments of the present disclosure, terms such as “first” and “second” are used in embodiments of the present disclosure to distinguish between same items or similar items that provide basically same functions or purposes. A person skilled in the art may understand that the terms such as “first” and “second” do not limit a quantity or an execution order, and the terms such as “first” and “second” do not indicate a definite difference.

It should be noted that information (including but not limited to user equipment information, personal information of a user, and the like), data (including but not limited to data used for analysis, stored data, displayed data, and the like), and signals in embodiments of the present disclosure are used under authorization by the user or full authorization by all parties, and capturing, use, and processing of related data need to conform to related laws, regulations, and standards of related countries and regions.

The foregoing descriptions are merely embodiments of the present disclosure, but are not intended to limit the present disclosure. Any modification, equivalent replacement, or improvement made without departing from the and principle of the present disclosure should fall within the protection scope of the present disclosure.

1. An audio encoding method, comprising:
framing an audio signal, to obtain a plurality of audio frames;
performing integer windowing and folding on the plurality of audio frames based on a windowing and folding matrix of a target window function, to obtain a plurality of folded audio frames;
performing integer time-frequency transform on the plurality of folded audio frames, to obtain a plurality of spectrums; and
encoding the plurality of spectrums into a bitstream.

2. The method according to claim 1, wherein the windowing and folding matrix is as follows:
$$F 1 = ( \begin{matrix}S & 0 \\ 0 & R\end{matrix} ) ( \begin{matrix}1 & \frac{{Sw}_{3} - 1}{- {Sw}_{1}} \\ 0 & 1\end{matrix} ) ( \begin{matrix}1 & 0 \\ - {Sw}_{1} & 1\end{matrix} ) ( \begin{matrix}1 & \frac{{Rw}_{2} - 1}{- {Sw}_{1}} \\ 0 & 1\end{matrix} ) ( \begin{matrix}S & 0 \\ 0 & R\end{matrix} ) ,$$
wherein
S represents taking a forward order of a sequence, R represents taking a reverse order of a sequence, the target window function is evenly divided into four parts, w₁ represents a function value of a first part of the target window function, w₂ represents a function value of a second part of the target window function, and w₃ represents a function value of a third part of the target window function.

3. The method according to claim 2, wherein the target window function is divided into an overlapping region and a non-overlapping region, and the overlapping region and the non-overlapping region meet the following conditions:
both the overlapping region and the non-overlapping region meet Sw₃*Rw₂+Rw₄*Sw₁=1, wherein w₄ represents a function value of a fourth part of the target window function;
w₄ in the non-overlapping region is 0; and
w₁ in the non-overlapping region is not 0, and values of
$$\frac{{Sw}_{3} - 1}{- {Sw}_{1}} and \frac{{Rw}_{2} - 1}{- {Sw}_{1}}$$
in the non-overlapping region fall within a specified range.

4. The method according to claim 3, wherein the specified range is [−128, 128].

5. The method according to claim 1, wherein after performing integer time-frequency transform on the plurality of folded audio frames, to obtain the plurality of spectrums, the method further comprises:
performing integer mid/side (INTMS) channel transform on the plurality of spectrums based on a channel transform matrix, and
wherein the encoding the plurality of spectrums into the bitstream comprises:
encoding the plurality of spectrums on which INTMS channel transform is performed into the bitstream.

6. The method according to claim 5, wherein the channel transform matrix is as follows:
$$H 1 = ( \begin{matrix}1 & \frac{cos θ 1 - 1}{sin θ 1} \\ 0 & 1\end{matrix} ) ( \begin{matrix}1 & 0 \\ sin θ 1 & 1\end{matrix} ) ( \begin{matrix}1 & \frac{cos θ 1 - 1}{sin θ 1} \\ 0 & 1\end{matrix} ) ,$$
wherein
θ1 represents an angle of rotation of channel transform.

7. An audio decoding method, comprising:
parsing out a plurality of spectrums from a bitstream;
performing integer time-frequency inverse transform on the plurality of spectrums, to obtain a plurality of first time-domain signals;
performing integer dewindowing and unfolding on the plurality of first time-domain signals based on a dewindowing and unfolding matrix of a target window function, to obtain a plurality of second time-domain signals; and
performing overlapping and addition on the plurality of second time-domain signals, to obtain a reconstructed audio signal.

8. The method according to claim 7, wherein the dewindowing and unfolding matrix is as follows:
$$F 2 = ( \begin{matrix}S & 0 \\ 0 & R\end{matrix} ) ( \begin{matrix}1 & \frac{{Sw}_{3} - 1}{{Sw}_{1}} \\ 0 & 1\end{matrix} ) ( \begin{matrix}1 & 0 \\ {Sw}_{1} & 1\end{matrix} ) ( \begin{matrix}1 & \frac{{Rw}_{2} - 1}{{Sw}_{1}} \\ 0 & 1\end{matrix} ) ( \begin{matrix}S & 0 \\ 0 & R\end{matrix} ) ,$$
wherein
S represents taking a forward order of a sequence, R represents taking a reverse order of a sequence, the target window function is evenly divided into four parts, w₁ represents a function value of a first part of the target window function, w₂ represents a function value of a second part of the target window function, and w₃ represents a function value of a third part of the target window function.

9. The method according to claim 7, wherein the target window function is divided into an overlapping region and a non-overlapping region, and the overlapping region and the non-overlapping region meet the following conditions:
both the overlapping region and the non-overlapping region meet Sw₃*Rw₂+Rw₄*Sw₁=1, wherein w₄ represents a function value of a fourth part of the target window function;
w₄ in the non-overlapping region is 0; and
w₁ in the non-overlapping region is not 0, and values of
$$\frac{{Sw}_{3} - 1}{- {Sw}_{1}} and \frac{{Rw}_{2} - 1}{- {Sw}_{1}}$$
in the non-overlapping region fall within a specified range.

10. The method according to claim 9, wherein the specified range is [−128, 128].

11. The method according to claim 7, wherein before performing integer time-frequency inverse transform on the plurality of spectrums, to obtain the plurality of first time-domain signals, the method further comprises:
performing integer inverse mid/side (INTIMS) channel transform on the plurality of spectrums based on a channel inverse transform matrix, and
wherein the performing integer time-frequency inverse transform on the plurality of spectrums, to obtain the plurality of first time-domain signals comprises:
performing integer time-frequency inverse transform on the plurality of spectrums on which INTIMS channel transform is performed, to obtain the plurality of first time-domain signals.

12. The method according to claim 11, wherein the channel inverse transform matrix is as follows:
$$H 2 = ( \begin{matrix}1 & \frac{- ( cos θ 2 - 1 )}{sin θ 2} \\ 0 & 1\end{matrix} ) ( \begin{matrix}1 & 0 \\ - sin θ 2 & 1\end{matrix} ) ( \begin{matrix}1 & \frac{- ( cos θ 2 - 1 )}{sin θ 2} \\ 0 & 1\end{matrix} ) ,$$
wherein
θ2 represents an angle of rotation of channel inverse transform.

13. An audio encoding device, comprising:
a memory storing programming instructions; and
one or more processors coupled to the memory,
wherein the one or more processors are configured to execute the programming instructions to cause the audio encoding device to:
frame an audio signal, to obtain a plurality of audio frames;
perform integer windowing and folding on the plurality of audio frames based on a windowing and folding matrix of a target window function, to obtain a plurality of folded audio frames;
perform integer time-frequency transform on the plurality of folded audio frames, to obtain a plurality of spectrums; and
encode the plurality of spectrums into a bitstream.

14. The audio encoding device according to claim 13, wherein the windowing and folding matrix is as follows:
$$F 1 = ( \begin{matrix}S & 0 \\ 0 & R\end{matrix} ) ( \begin{matrix}1 & \frac{{Sw}_{3} - 1}{- {Sw}_{1}} \\ 0 & 1\end{matrix} ) ( \begin{matrix}1 & 0 \\ - {Sw}_{1} & 1\end{matrix} ) ( \begin{matrix}1 & \frac{{Rw}_{2} - 1}{- {Sw}_{1}} \\ 0 & 1\end{matrix} ) ( \begin{matrix}S & 0 \\ 0 & R\end{matrix} ) ,$$
wherein
S represents taking a forward order of a sequence, R represents taking a reverse order of a sequence, the target window function is evenly divided into four parts, w₁ represents a function value of a first part of the target window function, w₂ represents a function value of a second part of the target window function, and w₃ represents a function value of a third part of the target window function.

15. The audio encoding device according to claim 14, wherein the target window function is divided into an overlapping region and a non-overlapping region, and the overlapping region and the non-overlapping region meet the following conditions:
both the overlapping region and the non-overlapping region meet Sw₃*Rw₂+Rw₄* Sw₁=1, wherein w₄ represents a function value of a fourth part of the target window function;
w₄ in the non-overlapping region is 0; and
w₁ in the non-overlapping region is not 0, and values of
$$\frac{{Sw}_{3} - 1}{- {Sw}_{1}} and \frac{{Rw}_{2} - 1}{- {Sw}_{1}}$$
in the non-overlapping region fall within a specified range.

16. The audio encoding device according to claim 15, wherein the specified range is [−128, 128].

17. An audio decoding device, comprising:
a memory storing programming instructions; and
one or more processors coupled to the memory,
wherein the one or more processors are configured to execute the programming instructions to cause the audio decoding device to:
parse out a plurality of spectrums from a bitstream;
perform integer time-frequency inverse transform on the plurality of spectrums, to obtain a plurality of first time-domain signals;
perform integer dewindowing and unfolding on the plurality of first time-domain signals based on a dewindowing and unfolding matrix of a target window function, to obtain a plurality of second time-domain signals; and
perform overlapping and addition on the plurality of second time-domain signals, to obtain a reconstructed audio signal.

18. The audio decoding device according to claim 17, wherein the dewindowing and unfolding matrix is as follows:
$$F 2 = ( \begin{matrix}S & 0 \\ 0 & R\end{matrix} ) ( \begin{matrix}1 & \frac{{Sw}_{3} - 1}{{Sw}_{1}} \\ 0 & 1\end{matrix} ) ( \begin{matrix}1 & 0 \\ {Sw}_{1} & 1\end{matrix} ) ( \begin{matrix}1 & \frac{{Rw}_{2} - 1}{{Sw}_{1}} \\ 0 & 1\end{matrix} ) ( \begin{matrix}S & 0 \\ 0 & R\end{matrix} ) ,$$
wherein
S represents taking a forward order of a sequence, R represents taking a reverse order of a sequence, the target window function is evenly divided into four parts, w₁ represents a function value of a first part of the target window function, w₂ represents a function value of a second part of the target window function, and w₃ represents a function value of a third part of the target window function.

19. The audio decoding device according to claim 18, wherein the target window function is divided into an overlapping region and a non-overlapping region, and the overlapping region and the non-overlapping region meet the following conditions:
both the overlapping region and the non-overlapping region meet Sw₃*Rw₂+Rw₄*Sw₁=1, wherein w₄ represents a function value of a fourth part of the target window function;
w₄ in the non-overlapping region is 0; and
w₁ in the non-overlapping region is not 0, and values of
$$\frac{{Sw}_{3} - 1}{- {Sw}_{1}} and \frac{{Rw}_{2} - 1}{- {Sw}_{1}}$$
in the non-overlapping region fall within a specified range.

20. The audio decoding device according to claim 17, wherein the one or more processors are further configured to execute the programming instructions to cause the audio decoding device to:
perform integer inverse mid/side (INTIMS) channel transform on the plurality of spectrums based on a channel inverse transform matrix; and
perform integer time-frequency inverse transform on the plurality of spectrums on which INTIMS channel transform is performed, to obtain the plurality of first time-domain signals.
